(19) United States
(12) Patent Application Publication
(10) Pub. No.: US 2026/0359728 A1
(43) Pub. Date: Nov. 12, 2026

(54) LEARNING SUPPORT DEVICE, OPERATION METHOD OF LEARNING SUPPORT DEVICE, AND OPERATION PROGRAM OF LEARNING SUPPORT DEVICE

(71) Applicant: FUJIFILM CORPORATION, Tokyo (JP)

(72) Inventor: Shotaro MISAWA, Tokyo (JP)

(21) Appl. No.: 19/720,923

(22) Filed: Jun. 26, 2026

Related U.S. Application Data
(63) Continuation of application No. PCT/JP2024/044661, filed on Dec. 17, 2024.

(30) Foreign Application Priority Data
Jan. 11, 2024 (JP) 2024-002884

(51) Int. Cl. G06N 20/00; G06F 40/166

(52) U.S. Cl. CPC G06N 20/00; G06F 40/166

(57) ABSTRACT

A learning support device including: a processor, in which the processor is configured to: acquire existing training data for a language model, which includes input data and ground-truth data, at least one of the input data or the ground-truth data being a text, the input data including a plurality of first constituent elements and the ground-truth data including a plurality of second constituent elements; derive an indicator representing a relationship between the first constituent element and the second constituent element; select a set of the first constituent element and the second constituent element for which the indicator satisfies a preset condition; and generate new training data by performing editing processing associated with the selected set on the existing training data.

### CROSS-REFERENCE TO RELATED APPLICATIONS

This application is a continuation application of International Application No. PCT/JP2024/044661, filed Dec. 17, 2024, the disclosure of which is incorporated herein by reference in its entirety. Further, this application claims priority from Japanese Patent Application No. 2024-002884, filed Jan. 11, 2024, the disclosure of which is incorporated herein by reference in its entirety.

### BACKGROUND

### 1. Technical Field

The technology of the present disclosure relates to a learning support device, an operation method of a learning support device, and an operation program of a learning support device.

In recent years, a language model such as bidirectional encoder representations from transformers (BERT) or chat generative pre-trained transformer (ChatGPT) has been attracting attention. In training of the language model, a large amount of training data (also referred to as supervised data) is required, and thus the training data is often insufficient. Therefore, for example, as described in “Bohan Li, et al. “Data augmentation approaches in natural language processing: A survey” AI Open Volume 3, 2022, Pages 71-90.”, data augmentation (DA) of generating new training data from existing training data is performed. “Bohan Li, et al. “Data augmentation approaches in natural language processing: A survey” AI Open Volume 3, 2022, Pages 71-90.” introduces various data augmentation methods such as rephrasing of words and sentences, insertion, replacement, or deletion of random words and sentences.

### SUMMARY

For example, a degree of relationship between an input text and an output text obtained by converting the input text, such as a summary text obtained by summarizing the input text, varies for each combination of sentences included in the input text and the output text. More specifically, in a case where the output text is the summary text, a sentence of the input text in which a content is included in a sentence of the summary text has a high relationship with the sentence of the summary text. On the other hand, a sentence of the input text in which a content is not included in the sentence of the summary text has a low relationship with the sentence of the summary text. Therefore, in a case where the new training data is generated by randomly deleting such sentences without taking into account that the degree of relationship between the sentences varies, and the new training data is used for training, there is a concern that a language model having low performance from which an expected output text cannot be obtained may be generated.

One embodiment according to the technology of the present disclosure provides a learning support device, an operation method of a learning support device, and an operation program of a learning support device capable of contributing to generation of a language model having higher performance than that in the related art.

A learning support device of the present disclosure comprises a processor, in which the processor is configured to: acquire existing training data for a language model, which includes input data and ground-truth data, at least one of the input data or the ground-truth data being a text, the input data including a plurality of first constituent elements and the ground-truth data including a plurality of second constituent elements; derive an indicator representing a relationship between the first constituent element and the second constituent element; select a set of the first constituent element and the second constituent element for which the indicator satisfies a preset condition; and generate new training data by performing editing processing associated with the selected set on the existing training data.

It is preferable that the indicator is at least one of a surface similarity between the first constituent element and the second constituent element, a semantic similarity between the first constituent element and the second constituent element, a keyword similarity between the first constituent element and the second constituent element, a numerical value corresponding to a result of topic classification of the first constituent element and the second constituent element, a numerical value corresponding to a determination result of textual entailment between the first constituent element and the second constituent element, or a coverage rate of, with respect to one of the first constituent element or the second constituent element, the other of the first constituent element or the second constituent element.

It is preferable that, in a case where the indicator is the coverage rate, the processor is configured to: perform a first selection of selecting a set of the first constituent element and the second constituent element for which the coverage rate satisfies a first selection condition; derive an integrated coverage rate of a common constituent element with respect to an integrated constituent element obtained by integrating two or more constituent elements of the other of the first constituent element and the second constituent element, the common constituent element being selected in common to the two or more constituent elements of the other and being a constituent element of the one of the first constituent element and the second constituent element; and perform a second selection of selecting a set of the first constituent element and the second constituent element for which the coverage rate satisfies a second selection condition more stringent than the first selection condition and selecting a set of the common constituent element and the integrated constituent element for which the integrated coverage rate satisfies the second selection condition.

It is preferable that the processor is configured to: derive the indicator between one of the first constituent elements and one of the second constituent elements; and the indicator between two or more of the first constituent elements and one of the second constituent elements.

It is preferable that the first constituent element and the second constituent element are each a sentence.

It is preferable that the processor is configured to: perform, as the editing processing, at least one of first editing processing of generating the new training data using only the selected sets of the first constituent element and the second constituent element in the existing training data, second editing processing of generating the new training data by integrating the selected sets of the first constituent element and the second constituent element in a plurality of pieces of the existing training data, third editing processing of generating the new training data by deleting the selected sets of the first constituent element and the second constituent element in the existing training data, or fourth editing processing of generating the new training data by changing an order of the selected sets of the first constituent element and the second constituent element in the existing training data.

It is preferable that the processor is configured to: use a sentence order arrangement model that arranges an order of sentences in an input text in a case where the new training data is generated by performing at least one of the second editing processing or the fourth editing processing.

It is preferable that the processor is configured to: select data to be formally adopted as training data from among candidates for a plurality of pieces of the new training data generated by the editing processing.

It is preferable that the processor is configured to: perform the selection based on a first degree of deviation between target new training data and the existing training data, which is a source of the target new training data, and new training data other than the target new training data, and a second degree of deviation between the target new training data and a set of the existing training data.

It is preferable that the processor is configured to: perform the selection using a text semantic determination model that outputs a score representing semantic clarity of an input text.

It is preferable that the language model is a model that performs a task of converting an input text into an output text of a different style.

It is preferable that the processor is configured to: train the language model using at least the new training data.

It is preferable that the processor is configured to: train the language model using the new training data, and then train the language model using the existing training data.

It is preferable that there are a plurality of types of the editing processing, and the processor is configured to: train the language model by providing the new training data generated for each of the plurality of types of editing processing to the language model in stages.

It is preferable that the processor is configured to: train the language model by providing the new training data to the language model in order from new training data having a relatively low training load.

An operation method of a learning support device of the present disclosure comprises acquiring existing training data for a language model, which includes input data and ground-truth data, at least one of the input data or the ground-truth data being a text, the input data including a plurality of first constituent elements and the ground-truth data including a plurality of second constituent elements, deriving an indicator representing a relationship between the first constituent element and the second constituent element, selecting a set of the first constituent element and the second constituent element for which the indicator satisfies a preset condition, and generating new training data by performing editing processing associated with the selected set on the existing training data.

An operation program of a learning support device of the present disclosure causes a computer to execute a process comprising: acquiring existing training data for a language model, which includes input data and ground-truth data, at least one of the input data or the ground-truth data being a text, the input data including a plurality of first constituent elements and the ground-truth data including a plurality of second constituent elements; deriving an indicator representing a relationship between the first constituent element and the second constituent element; selecting a set of the first constituent element and the second constituent element for which the indicator satisfies a preset condition; and generating new training data by performing editing processing associated with the selected set on the existing training data.

According to the technology of the present disclosure, it is possible to provide the learning support device, the operation method of a learning support device, and the operation program of a learning support device capable of contributing to the generation of the language model having higher performance than that in the related art.

### BRIEF DESCRIPTION OF THE DRAWINGS

FIG. 1 is a diagram showing a learning support system.

FIG. 2 is a diagram showing a task of a language model.

FIG. 3 is a diagram showing existing training data.

FIG. 4 is a diagram showing new training data.

FIG. 5 is a block diagram showing computers constituting a data augmentation device and a learning device.

FIG. 6 is a block diagram showing a processing unit of a CPU of the data augmentation device.

FIG. 7 is a diagram showing a segmentation result.

FIG. 8 is a diagram showing a target for deriving an indicator.

FIG. 9 is a diagram showing a specific content of the indicator.

FIG. 10 is a diagram showing a derivation result.

FIG. 11 is a diagram showing a process of a set selection unit.

FIG. 12 is a diagram showing first editing processing.

FIG. 13 is a diagram showing another example of the first editing processing.

FIG. 14 is a diagram showing second editing processing.

FIG. 15 is a diagram showing third editing processing.

FIG. 16 is a diagram showing fourth editing processing.

FIG. 17 is a block diagram showing a processing unit of a CPU of the learning device.

FIG. 18 is a diagram showing a training procedure of a language model using the existing training data.

FIG. 19 is a diagram showing a training procedure of a language model using the new training data.

FIG. 20 is a flowchart showing a processing procedure of the data augmentation device.

FIG. 21 is a flowchart showing a processing procedure of the learning device.

FIG. 22 is a diagram showing another example of the target for deriving the indicator.

FIG. 23 is a diagram showing an example of narrowing down the target for deriving the indicator based on a combination condition.

FIG. 24 is a diagram showing another example of the derivation result.

FIG. 25 is a diagram showing fifth editing processing.

FIG. 26 is a diagram showing sixth editing processing.

FIG. 27 is a diagram showing another example of the third editing processing.

FIG. 28 is a diagram showing a derivation result of an aspect in which a recall of an existing input data sentence with respect to an existing ground-truth data sentence is derived as the indicator.

FIG. 29 is a diagram showing a process of a set selection unit in a case where the indicator is the recall.

FIG. 30 is a block diagram showing a processing unit of an aspect in which a first selection and a second selection are performed.

FIG. 31 is a diagram showing integration processing.

FIG. 32 is a diagram showing derivation processing of an integrated recall.

FIG. 33 is a diagram showing a task of a sentence order arrangement model.

FIG. 34 is a diagram showing an example of a text.

FIG. 35 is a diagram showing a usage example of the sentence order arrangement model.

FIG. 36 is a diagram showing another usage example of the sentence order arrangement model.

FIG. 37 is a block diagram showing a processing unit of Embodiment 2_1.

FIG. 38 is a diagram showing a detailed configuration of a selection unit.

FIG. 39 is a graph for describing a process of a first calculation unit.

FIG. 40 is a graph for describing a process of a second calculation unit.

FIG. 41 is a diagram showing a selection condition of Embodiment 2_1.

FIG. 42 is a block diagram showing a processing unit of Embodiment 2_2.

FIG. 43 is a diagram showing a task of a text semantic determination model.

FIG. 44 is a diagram showing the task of the text semantic determination model.

FIG. 45 is a diagram showing an aspect in which new training input data and new ground-truth data are input to the text semantic determination model, a score is output from the text semantic determination model, and a score average value is further calculated.

FIG. 46 is a diagram showing a selection condition of Embodiment 2_2.

FIG. 47 is a diagram showing a training schedule of the language model.

FIG. 48 is a diagram showing a training load of the new training data.

FIG. 49 is a diagram showing an aspect in which the language model is trained by providing the new training data in a stepwise manner.

FIG. 50 is a diagram showing a task of a set selection determination model.

FIG. 51 is a flowchart showing a procedure of a process using the set selection determination model.

FIG. 52 is a diagram showing an example in which input data is numerical data.

FIG. 53 is a diagram showing an example in which the input data is audio recognition data.

### DETAILED DESCRIPTION

### Embodiment 1

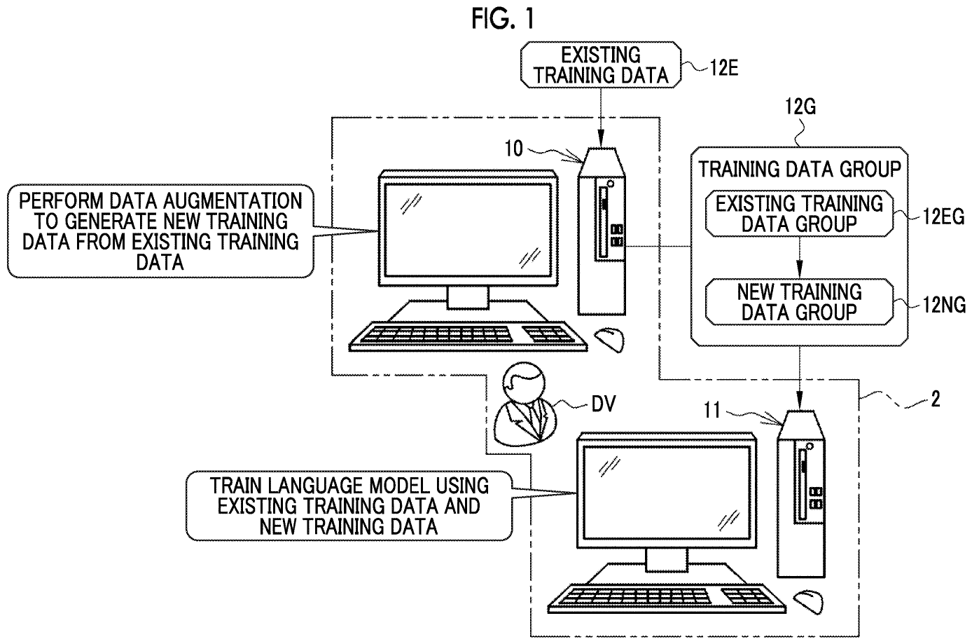

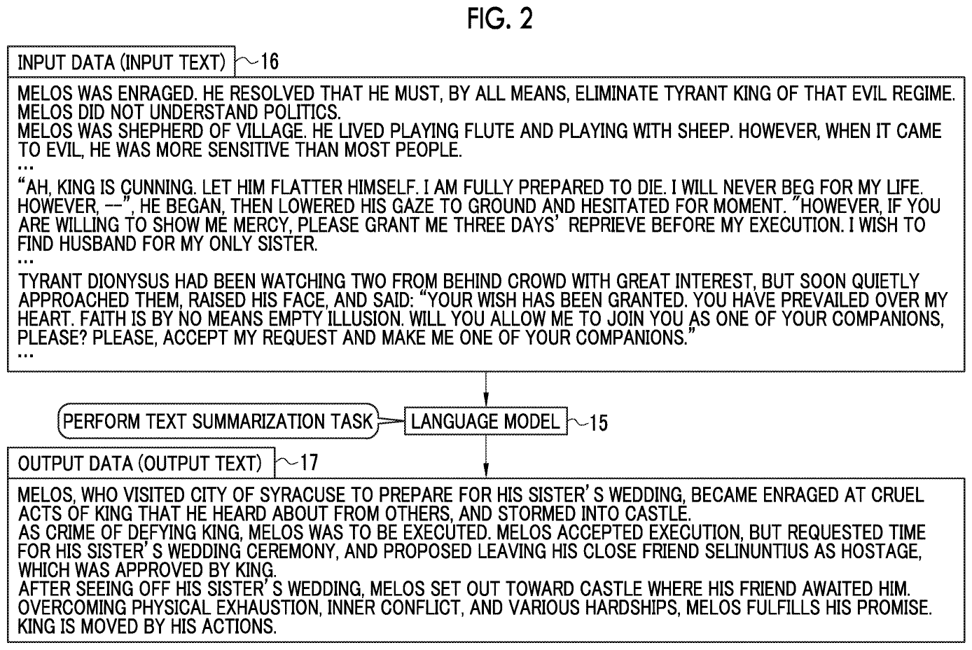

As shown in FIG. 1 as an example, a learning support system 2 is a system that supports training of a language model 15 (see FIG. 2), and is installed in a development company or the like of the language model 15. The learning support system 2 is composed of a data augmentation device 10 and a learning device 11. The data augmentation device 10 and the learning device 11 are, for example, desktop personal computers and are operated by a developer DV of the language model 15. The data augmentation device 10 and the learning device 11 are connected to each other to be communicable with each other via a computer network such as a local area network (LAN).

Both the data augmentation device 10 and the learning device 11 are examples of a “learning support device” according to the technology of the present disclosure. As described above, the “learning support device” according to the technology of the present disclosure may be composed of a plurality of computers. A single computer may be assigned with functions of the data augmentation device 10 and the learning device 11, and the single computer may be operated as the “learning support device” according to the technology of the present disclosure.

The developer DV collects data considered to be useful for the training in consideration of the task of the language model 15 and inputs the collected data to the data augmentation device 10 as existing training data 12E. As a result, the data augmentation device 10 acquires an existing training data group 12EG that is a set of a plurality of pieces of the existing training data 12E.

The data augmentation device 10 performs data augmentation of generating new training data 12N (see FIG. 4) from the existing training data 12E. With this data augmentation, the data augmentation device 10 has a new training data group 12NG that is a set of a plurality of pieces of the new training data 12N. The data augmentation device 10 distributes and outputs a training data group 12G composed of the existing training data group 12EG and the new training data group 12NG to the learning device 11. The learning device 11 trains the language model 15 using the existing training data 12E and the new training data 12N. In the following, the existing training data 12E and the new training data 12N may be collectively referred to as training data 12.

As shown in FIG. 2 as an example, the language model 15 is a model that performs a text summarization task of converting input data 16, which is an input text, into output data 17, which is a summary text. That is, the language model 15 is an example of a “model that performs a task of converting an input text into an output text of a different style” according to the technology of the present disclosure. The language model 15 is, for example, BERT, ChatGPT, or the like. Here, in the present specification, a text is defined as a collection of a plurality of sentences. In addition, a sentence is defined as a collection of a plurality of words separated by a period. However, for example, a sentence of 200 characters or more (a compound sentence, a complex sentence, a duplicate sentence, or the like) is defined as a text as an exception. The sentence is an example of a “constituent element” according to the technology of the present disclosure. In FIG. 2, “Run, Melos” by Dazai Osamu is shown as an example of the input data 16, and a summary text thereof is shown as an example of the output data 17, but these are merely examples. A factory maintenance report described in detail may be the input data 16, and a text summarizing an abnormal portion and a cause thereof may be the output data 17.

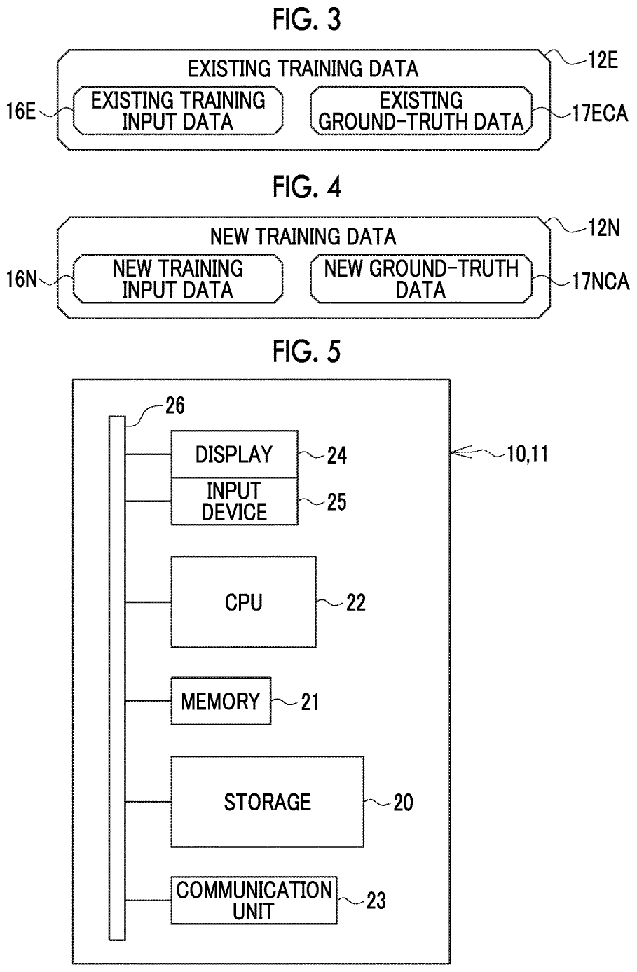

As shown in FIG. 3 as an example, the existing training data 12E is composed of existing training input data 16E and existing ground-truth data 17ECA. In addition, as shown in FIG. 4 as an example, the new training data 12N is composed of new training input data 16N and new ground-truth data 17NCA. The existing training input data 16E and the existing ground-truth data 17ECA, and the new training input data 16N and the new ground-truth data 17NCA are also texts including a plurality of sentences. The existing ground-truth data 17ECA is a summary text of the existing training input data 16E, and the new ground-truth data 17NCA is a summary text of the new training input data 16N.

The existing training input data 16E and the new training input data 16N are data input to the language model 15 during training. The existing ground-truth data 17ECA and the new ground-truth data 17NCA are data for checking answers, so to speak, for comparing the existing training output data 17E (see FIG. 18) and new training output data 17N (see FIG. 19) output from the language model 15 in response to the input of the existing training input data 16E and the new training input data 16N. The existing training input data 16E is an example of “input data” according to the technology of the present disclosure. In addition, the existing ground-truth data 17ECA is an example of “ground-truth data” according to the technology of the present disclosure.

As shown in FIG. 5 as an example, the computers constituting the data augmentation device 10 and the learning device 11 comprise a storage 20, a memory 21, a central processing unit (CPU) 22, a communication unit 23, a display 24, and an input device 25. These units are connected to each other through a bus line 26.

The storage 20 is a hard disk drive that is built in the computers constituting the data augmentation device 10 and the learning device 11 or is connected to the computers via a cable or a network. Alternatively, the storage 20 is a disk array provided with a plurality of hard disk drives. The storage 20 stores a control program such as an operating system, various application programs, and various data associated with the programs. Note that a solid-state drive may be used instead of the hard disk drive.

The memory 21 is a work memory used by the CPU 22 to execute processing. The CPU 22 loads the program stored in the storage 20 to the memory 21, and executes processing in accordance with the program. Thereby, the CPU 22 collectively controls each unit of the computer. The CPU 22 is an example of a “processor” according to the technology of the present disclosure. It is noted that the memory 21 may be built in the CPU 22.

The communication unit 23 is a network interface to perform transmission control of various kinds of information through the network. The display 24 displays various screens. The various screens comprise an operation function using a graphical user interface (GUI). The computers constituting the data augmentation device 10 and the learning device 11 receive an input of an operation instruction from the input device 25 through the various screens. The input device 25 is, for example, a keyboard, a mouse, a touch panel, and a microphone for voice input.

Further, in the following description, the subscript “A” is attached to the reference numerals indicating each unit (the storage 20 and the CPU 22) of the computer constituting the data augmentation device 10, and the subscript “B” is attached to the reference numerals indicating each unit (the storage 20 and the CPU 22) of the computer constituting the learning device 11 to distinguish the units.

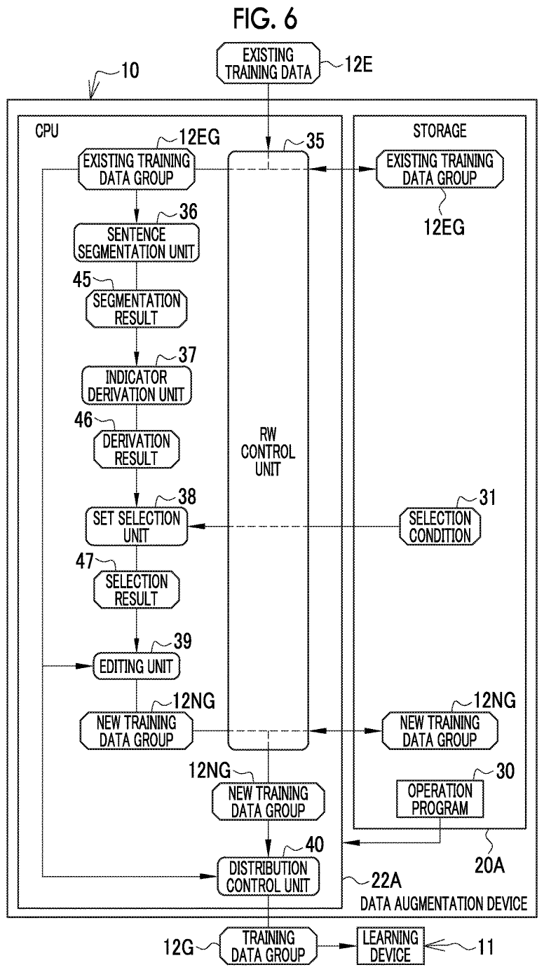

As shown in FIG. 6 as an example, a storage 20A of the data augmentation device 10 stores an operation program 30. The operation program 30 is an application program for causing the computer to function as the data augmentation device 10. That is, the operation program 30 is an example of “an operation program of a learning support device” according to the technology of the present disclosure. The storage 20A also stores a selection condition 31 and the like. The selection condition 31 is an example of a “preset condition” according to the technology of the present disclosure.

In a case in which the operation program 30 is activated, the CPU 22A of the computer constituting the data augmentation device 10 functions as a read/write (hereinafter, abbreviated as RW) control unit 35, a sentence segmentation unit 36, an indicator derivation unit 37, a set selection unit 38, an editing unit 39, and a distribution control unit 40 in cooperation with the memory 21 and the like.

The RW control unit 35 controls storing of various types of data in the storage 20A and reading of various types of data from the storage 20A. For example, the RW control unit 35 stores the existing training data 12E in the storage 20A. In addition, the RW control unit 35 reads out the existing training data group 12EG from the storage 20A and outputs the readout existing training data group 12EG to the sentence segmentation unit 36, the editing unit 39, and the distribution control unit 40. Further, the RW control unit 35 reads out the selection condition 31 from the storage 20A and outputs the readout selection condition 31 to the set selection unit 38.

The sentence segmentation unit 36 segments the texts of the existing training input data 16E and the existing ground-truth data 17ECA of each existing training data 12E of the existing training data group 12EG into individual sentences. The sentence segmentation unit 36 outputs a segmentation result 45 of the sentences to the indicator derivation unit 37.

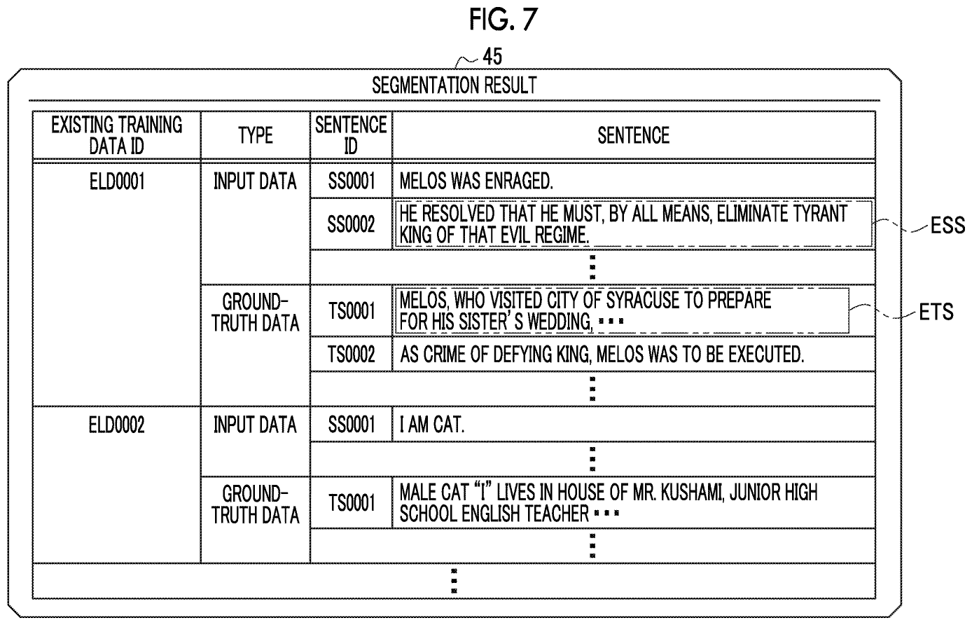

As shown in FIG. 7 as an example, the segmentation result 45 is obtained by assigning and registering a sentence identification data (ID) to each sentence included in each of the existing training input data 16E and the existing ground-truth data 17ECA for each existing training data ID for uniquely identifying the existing training data 12E (for each existing training data 12E). The sentence ID in a case of a sentence included in the existing training input data 16E (sentence of which the type is “input data” in FIG. 7) is obtained by adding a number in the order of appearance to SS, which is an abbreviation for Source Sentence. The sentence ID in a case of a sentence included in the existing ground-truth data 17ECA (sentence of which the type is “ground-truth data” in FIG. 7) is obtained by adding a number in the order of appearance to TS, which is an abbreviation for Target Sentence. In the following, the sentence included in the existing training input data 16E is referred to as an existing input data sentence ESS. In addition, the sentence included in the existing ground-truth data 17ECA is referred to as an existing ground-truth data sentence ETS. The existing input data sentence ESS is an example of a “first constituent element” according to the technology of the present disclosure. In addition, the existing ground-truth data sentence ETS is an example of a “second constituent element” according to the technology of the present disclosure.

In FIG. 6, the indicator derivation unit 37 derives an indicator INX (see FIG. 9) representing a relationship between the existing input data sentence ESS and the existing ground-truth data sentence ETS for each existing training data 12E. The indicator derivation unit 37 outputs a derivation result 46 of the indicator INX to the set selection unit 38.

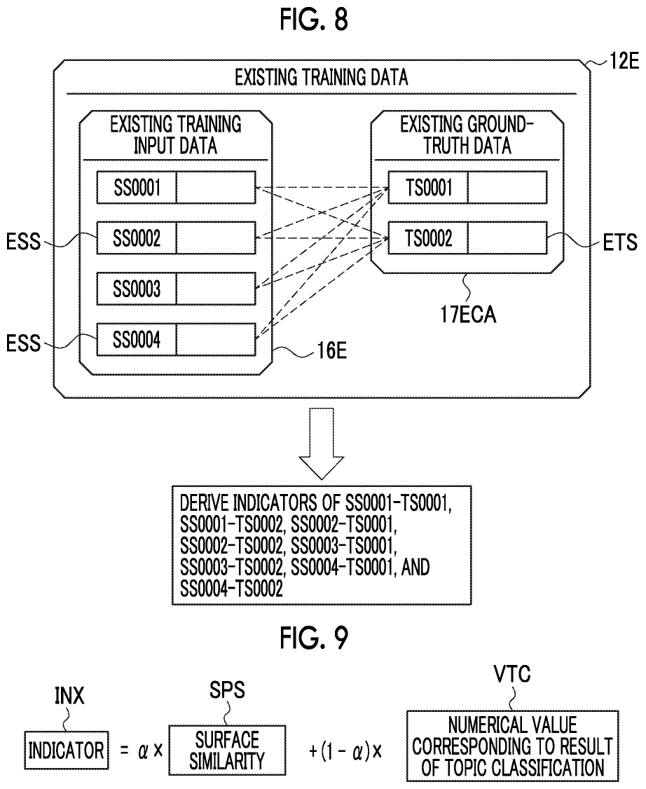

As shown in FIG. 8 as an example, the indicator derivation unit 37 derives the indicator INX of a plurality of the existing input data sentences ESS and a plurality of the existing ground-truth data sentences ETS in a brute-force manner. FIG. 8 shows a case where there are four existing input data sentences ESS having sentence IDs “SS0001” to “SS0004” and two existing ground-truth data sentences ETS having sentence IDs “TS0001” and “TS0002”. In this case, as shown in a broken line and a lower part of an arrow, the indicator derivation unit 37 derives the indicators INX of “SS0001-TS0001”, “SS0001-TS0002”, “SS0002-TS0001”, “SS0002-TS0002”, “SS0003-TS0001”, “SS0003-TS0002”, “SS0004-TS0001”, and “SS0004-TS0002”. The “-” connecting the sentence ID of the existing input data sentence ESS and the sentence ID of the existing ground-truth data sentence ETS means that a set of the existing input data sentence ESS and the existing ground-truth data sentence ETS having the sentence ID is a target for which the indicator INX is derived.

As shown in FIG. 9 as an example, the indicator INX is obtained by weighting a surface similarity SPS between the existing input data sentence ESS and the existing ground-truth data sentence ETS and a numerical value VTC corresponding to a result of topic classification of the existing input data sentence ESS and the existing ground-truth data sentence ETS with α and (1−α), respectively. α is a value that is optionally set to control a balance between the surface similarity SPS and the numerical value VTC, and is 0<α<1. Both the surface similarity SPS and the numerical value VTC corresponding to the result of the topic classification are numerical values having a minimum value of 0 and a maximum value of 1. A semantic similarity SMS between the existing input data sentence ESS and the existing ground-truth data sentence ETS and a keyword similarity KM between the existing input data sentence ESS and the existing ground-truth data sentence ETS, which will be described below, are also numerical values having a minimum value of 0 and a maximum value of 1.

The surface similarity SPS is a so-called appearance similarity between sentences, which is derived based on a ratio of match between words constituting the existing input data sentence ESS and words constituting the existing ground-truth data sentence ETS, a ratio of match between an order of the words, and the like. The surface similarity SPS indicates that the existing input data sentence ESS and the existing ground-truth data sentence ETS are not similar to each other at the surface level as the surface similarity SPS is closer to 0, and indicates that the existing input data sentence ESS and the existing ground-truth data sentence ETS are similar to each other at the surface level as the surface similarity SPS is closer to 1. The indicator derivation unit 37 derives, for example, a known evaluation indicator such as a recall-oriented understudy for gisting evaluation (ROUGE), a bilingual evaluation understudy (BLEU), a consensus-based image description evaluation (CIDEr), or a metric for evaluation of translation with explicit ordering (METEOR) as the surface similarity SPS.

While the surface similarity SPS is a so-called appearance similarity between sentences, the semantic similarity SMS is a semantic similarity between the existing input data sentence ESS and the existing ground-truth data sentence ETS. The semantic similarity SMS indicates that the existing input data sentence ESS and the existing ground-truth data sentence ETS are not semantically similar to each other as the semantic similarity SMS is closer to 0, and indicates that the existing input data sentence ESS and the existing ground-truth data sentence ETS are semantically similar to each other as the semantic similarity SMS is closer to 1. The indicator derivation unit 37 derives the semantic similarity SMS using, for example, a known model such as Sentence BERT or BERT Score.

The keyword similarity KM is a surface similarity narrowed down to nouns and proper nouns among the words constituting the existing input data sentence ESS and the existing ground-truth data sentence ETS.

The indicator derivation unit 37 derives a numerical value VTC corresponding to a result of topic classification as follows, for example. That is, the indicator derivation unit 37 performs clustering such as latent Dirichlet allocation (LDA) on the existing input data sentence ESS and the existing ground-truth data sentence ETS to specify a topic inherent in the existing input data sentence ESS and the existing ground-truth data sentence ETS. Next, the indicator derivation unit 37 derives the numerical value VTC corresponding to a ratio of match between the topics of the existing input data sentence ESS and the existing ground-truth data sentence ETS. In order to facilitate the specification of the topic, the developer DV may register a keyword for each topic. The topic is a matter taken up in a sentence. For example, a sentence “The American president and the Japanese prime minister played golf” has three topics of politics, international, and sports.

The indicator derivation unit 37 derives a numerical value VIR corresponding to a determination result of textual entailment as follows, for example. That is, the indicator derivation unit 37 inputs the existing input data sentence ESS and the existing ground-truth data sentence ETS to a known recognizing textual entailment (RTE) model or a natural language inference (NLI) model. The model outputs the probability that textual entailment holds between the input existing input data sentence ESS and the existing ground-truth data sentence ETS, and the probability is set as the numerical value VIR corresponding to the determination result of the textual entailment. The textual entailment between sentences refers to, for example, a relationship in which, in a case where a sentence “Bach, who is a composer representing baroque music, published ‘Air on G String’ around 1730” is established, a sentence “The author of ‘Air on G String’is Bach” is also established.

The indicator INX is not limited to the weighted addition of the surface similarity SPS and the numerical value VTC corresponding to the result of the topic classification, and may be an arithmetic mean or a weighted average of the surface similarity SPS and the numerical value VTC. In addition, in a case where it is determined that there is textual entailment, a numerical value obtained by adding, for example, 0.1 to the arithmetic mean value or the weighted average value of the surface similarity SPS and the numerical value VTC corresponding to the result of the topic classification may be used as the indicator INX, and in a case where it is determined that there is no textual entailment, a numerical value obtained by subtracting, for example, 0.1 from the arithmetic mean value or the weighted average value may be used as the indicator INX. The indicator INX may include the semantic similarity SMS, the keyword similarity KM, and the numerical value VIR corresponding to the determination result of the textual entailment, in addition to the surface similarity SPS and the numerical value VTC corresponding to the result of the topic classification. The indicator INX need only include at least one of the surface similarity SPS, the semantic similarity SMS, the keyword similarity KM, the numerical value VTC corresponding to the result of the topic classification, or the numerical value VIR corresponding to the determination result of the textual entailment.

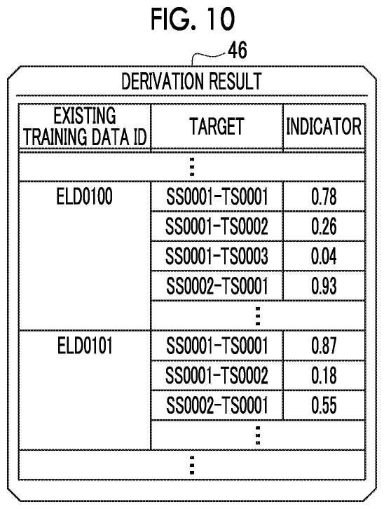

As shown in FIG. 10 as an example, the derivation result 46 is a result in which the indicator INX of each set of the existing input data sentence ESS and the existing ground-truth data sentence ETS is registered for each existing training data ID (for each existing training data 12E).

In FIG. 6, the set selection unit 38 selects a set of the existing input data sentence ESS and the existing ground-truth data sentence ETS for which the indicator INX satisfies the selection condition 31. The set selection unit 38 outputs a selection result 47 of the set to the editing unit 39.

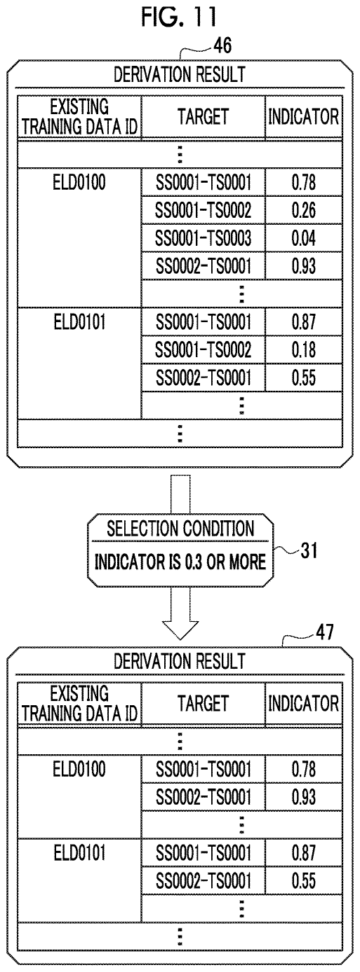

As shown in FIG. 11 as an example, the selection condition 31 is, for example, that the indicator INX is 0.3 or more. Therefore, the set selection unit 38 extracts a set of the existing input data sentence ESS and the existing ground-truth data sentence ETS in which the indicator INX is 0.3 or more from the derivation result 46 to obtain the selection result 47. In other words, the set selection unit 38 deletes a set of the existing input data sentence ESS and the existing ground-truth data sentence ETS in which the indicator INX is less than 0.3 from the derivation result 46 to obtain the selection result 47. The selection condition 31 may be, for example, that the indicator INX is within the top 30%. Alternatively, the selection condition 31 may be that the indicator INX is 0.3 or more and is within the top 30%.

In FIG. 6, the editing unit 39 generates the new training data 12N by performing the editing processing associated with the set of the existing input data sentence ESS and the existing ground-truth data sentence ETS registered in the selection result 47 on the existing training data 12E. The editing unit 39 generates a plurality of pieces of new training data 12N and outputs a new training data group 12NG, which is a set of the plurality of pieces of new training data 12N, to the RW control unit 35. The RW control unit 35 stores the new training data group 12NG in the storage 20A.

The RW control unit 35 reads out the existing training data group 12EG and the new training data group 12NG from the storage 20A in response to the distribution instruction of the training data group 12G from the developer DV through the input device 25. The readout existing training data group 12EG and new training data group 12NG are output to the distribution control unit 40. The distribution control unit 40 distributes and outputs the training data group 12G composed of the existing training data group 12EG and the new training data group 12NG to the learning device 11 designated by the distribution instruction.

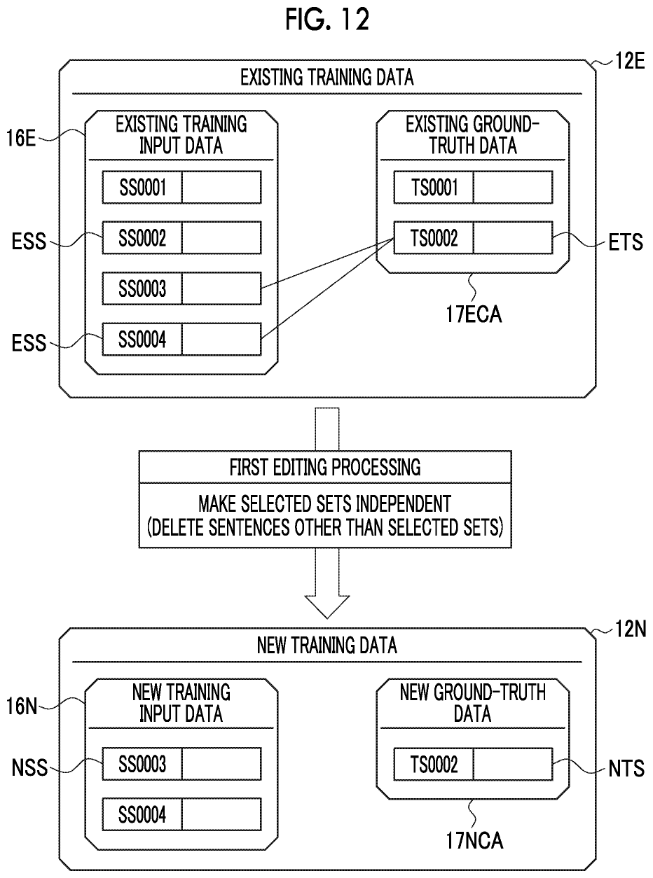

As shown in FIGS. 12 to 16 as an example, the editing unit 39 performs four types of editing processing of first editing processing, second editing processing, third editing processing, and fourth editing processing. In FIGS. 12 to 16, the existing input data sentence ESS and the existing ground-truth data sentence ETS connected by a thin solid line are a set of the existing input data sentence ESS and the existing ground-truth data sentence ETS selected by the set selection unit 38. The same applies to the following drawings.

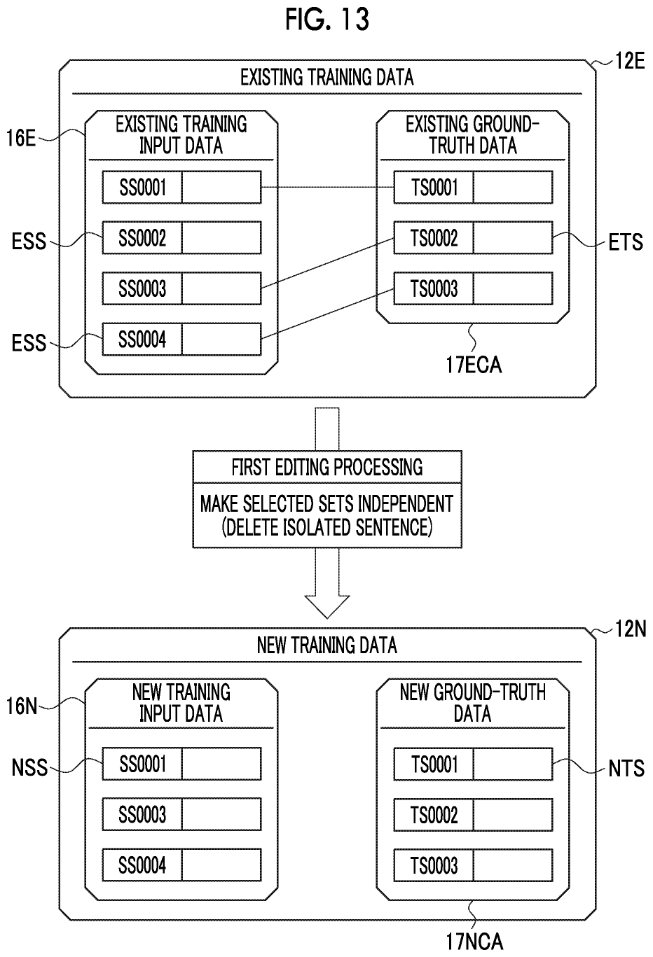

FIGS. 12 and 13 show the first editing processing. The first editing processing is processing of generating the new training data 12N with only the selected sets of the existing input data sentence ESS and the existing ground-truth data sentence ETS by making the selected sets of the existing input data sentence ESS and the existing ground-truth data sentence ETS in the existing training data 12E independent. In other words, the first editing processing is processing of deleting sentences other than the selected sets of the existing input data sentence ESS and the existing ground-truth data sentence ETS.

FIG. 12 shows a case where sets of the existing input data sentences ESS having sentence IDs “SS0003” and “SS0004” and the existing ground-truth data sentence ETS having a sentence ID “TS0002” are selected. In this case, the editing unit 39 deletes the existing input data sentences ESS having sentence IDs “SS0001” and “SS0002” and the existing ground-truth data sentence ETS having a sentence ID “TS0001” and generates the new training data 12N with only the sets of the existing input data sentences ESS having the sentence IDs “SS0003” and “SS0004” and the existing ground-truth data sentence ETS having the sentence ID “TS0002”. More specifically, the new training input data 16N is generated with the existing input data sentences ESS having the sentence IDs “SS0003” and “SS0004”. In addition, the new ground-truth data 17NCA is generated with the existing ground-truth data sentence ETS having the sentence ID “TS0002”. As can be seen from the example of FIG. 12, a plurality of existing input data sentences ESS may be selected for one existing ground-truth data sentence ETS. On the contrary, a plurality of existing ground-truth data sentences ETS may be selected for one existing input data sentence ESS. In the following, the sentence included in the new training input data 16N is referred to as a new input data sentence NSS. In addition, the sentence included in the new ground-truth data 17NCA is referred to as a new ground-truth data sentence NTS.

FIG. 13 shows a case where a set of the existing input data sentence ESS having a sentence ID “SS0001” and the existing ground-truth data sentence ETS having a sentence ID “TS0001”, a set of the existing input data sentence ESS having a sentence ID “SS0003” and the existing ground-truth data sentence ETS having a sentence ID “TS0002”, and a set of the existing input data sentence ESS having a sentence ID “SS0004” and the existing ground-truth data sentence ETS having a sentence ID “TS0003” are selected. In this case, the editing unit 39 deletes the existing input data sentence ESS having the isolated sentence ID “SS0002” and generates the new training data 12N with only the sets of the existing input data sentences ESS having sentence IDs “SS0001”, “SS0003”, and “SS0004” and the existing ground-truth data sentences ETS having sentence IDs “TS0001”, “TS0002”, and “TS0003”. More specifically, the new training input data 16N is generated with the existing input data sentences ESS having the sentence IDs “SS0001”, “SS0003”, and “SS0004”. In addition, the new ground-truth data 17NCA is generated with the existing ground-truth data sentences ETS having the sentence IDs “TS0001”, “TS0002”, and “TS0003”. As can be seen from this example, one of the new training input data 16N and the new ground-truth data 17NCA may be data obtained by copying the existing training input data 16E or the existing ground-truth data 17ECA as it is.

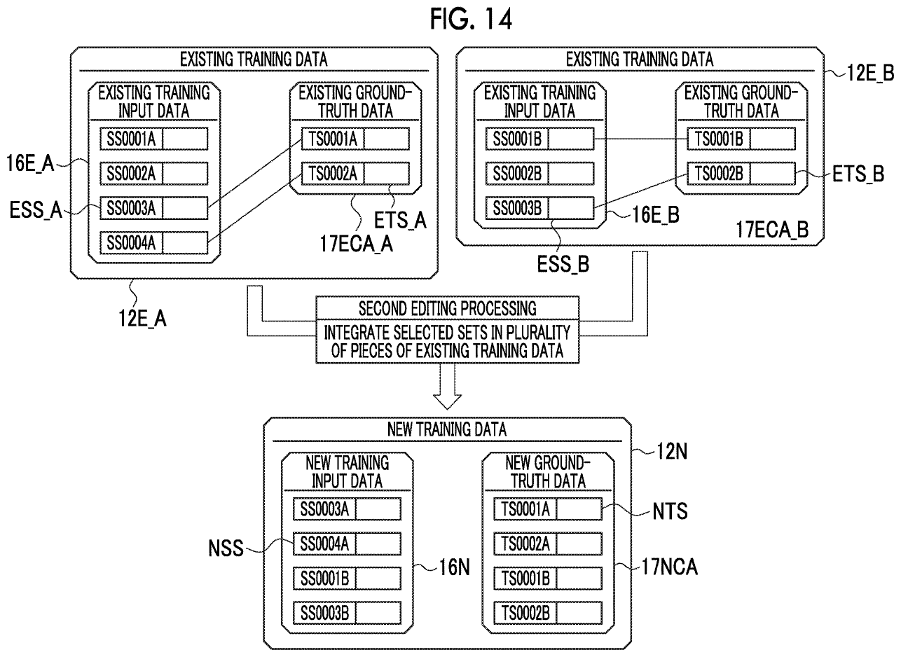

FIG. 14 shows the second editing processing. The second editing processing is processing of integrating the selected set of the existing input data sentence ESS and the existing ground-truth data sentence ETS in the plurality of pieces of existing training data 12E to generate the new training data 12N. A plurality of pieces of existing training data 12E to be integrated in the second editing processing are, for example, existing training data 12E in which an average value of indicator INX for all combinations of the existing input data sentences ESS is 0.7 or greater.

FIG. 14 shows a case where the sentences of two pieces of existing training data 12E_A and existing training data 12E_B are integrated to generate the new training data 12N. In addition, FIG. 14 shows a case where a set of the existing input data sentence ESS_A having the sentence ID “SS0003A” and the existing ground-truth data sentence ETS_A having the sentence ID “TS0001A” in the existing training data 12E_A and a set of the existing input data sentence ESS_A having the sentence ID “SS0004A” and the existing ground-truth data sentence ETS_A having the sentence ID “TS0002A” in the existing training data 12E_A are selected. Further, FIG. 14 shows a case where a set of the existing input data sentence ESS_B having the sentence ID “SS0001B” and the existing ground-truth data sentence ETS_B having the sentence ID “TS0001B” in the existing training data 12E_B and a set of the existing input data sentence ESS_B having the sentence ID “SS0003B” and the existing ground-truth data sentence ETS_B having the sentence ID “TS0002B” in the existing training data 12E_B are selected.

In this case, the editing unit 39 extracts a set of the existing input data sentence ESS_A having the sentence ID “SS0003A” and the existing ground-truth data sentence ETS_A having the sentence ID “TS0001A” and a set of the existing input data sentence ESS_A having the sentence ID “SS0004A” and the existing ground-truth data sentence ETS_A having the sentence ID “TS0002A” from the existing training data 12E_A. Further, the editing unit 39 extracts a set of the existing input data sentence ESS_B having the sentence ID “SS0001B” and the existing ground-truth data sentence ETS_B having the sentence ID “TS0001B” and a set of the existing input data sentence ESS_B having the sentence ID “SS0003B” and the existing ground-truth data sentence ETS_B having the sentence ID “TS0002B” from the existing training data 12E_B. The sentences are integrated to generate the new training data 12N. More specifically, the new training input data 16N is generated using the existing input data sentence ESS_A having the sentence IDs “SS0003A” and “SS0004A” and the existing input data sentence ESS_B having the sentence IDs “SS0001B” and “SS0003B”. In addition, the new ground-truth data 17NCA is generated by the existing ground-truth data sentence ETS_A having the sentence IDs “TS0001A” and “TS0002A” and the existing ground-truth data sentence ETS_B having the sentence IDs “TS0001B” and “TS0002B”.

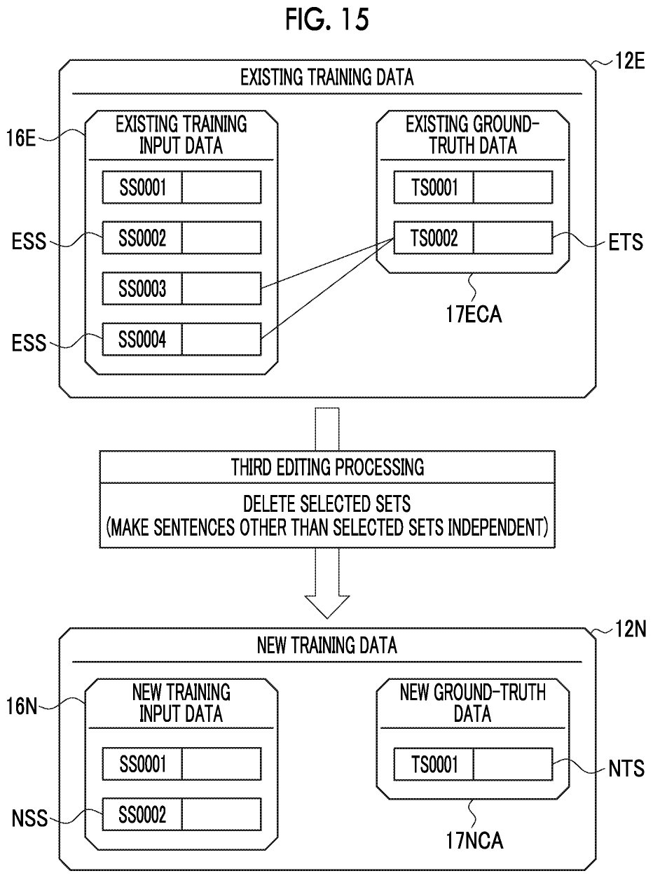

FIG. 15 shows the third editing processing. The third editing processing is processing of deleting the selected set of the existing input data sentence ESS and the existing ground-truth data sentence ETS in the existing training data 12E to generate the new training data 12N. In other words, the third editing processing is processing of making sentences other than the selected sets of the existing input data sentence ESS and the existing ground-truth data sentence ETS independent. That is, the third editing processing is processing that is opposite to the first editing processing.

FIG. 15 shows a case where sets of the existing input data sentences ESS having sentence IDs “SS0003” and “SS0004” and the existing ground-truth data sentence ETS having a sentence ID “TS0002” are selected, as in the case of FIG. 12. In this case, the editing unit 39 deletes the existing input data sentences ESS having sentence IDs “SS0003” and “SS0004” and the existing ground-truth data sentence ETS having a sentence ID “TS0002” and generates the new training data 12N with only the sets of the existing input data sentences ESS having the sentence IDs “SS0001” and “SS0002” and the existing ground-truth data sentence ETS having the sentence ID “TS0001”. More specifically, the new training input data 16N is generated with the existing input data sentences ESS having the sentence IDs “SS0001” and “SS0002”. In addition, the new ground-truth data 17NCA is generated with the existing ground-truth data sentence ETS having the sentence ID “TS0001”.

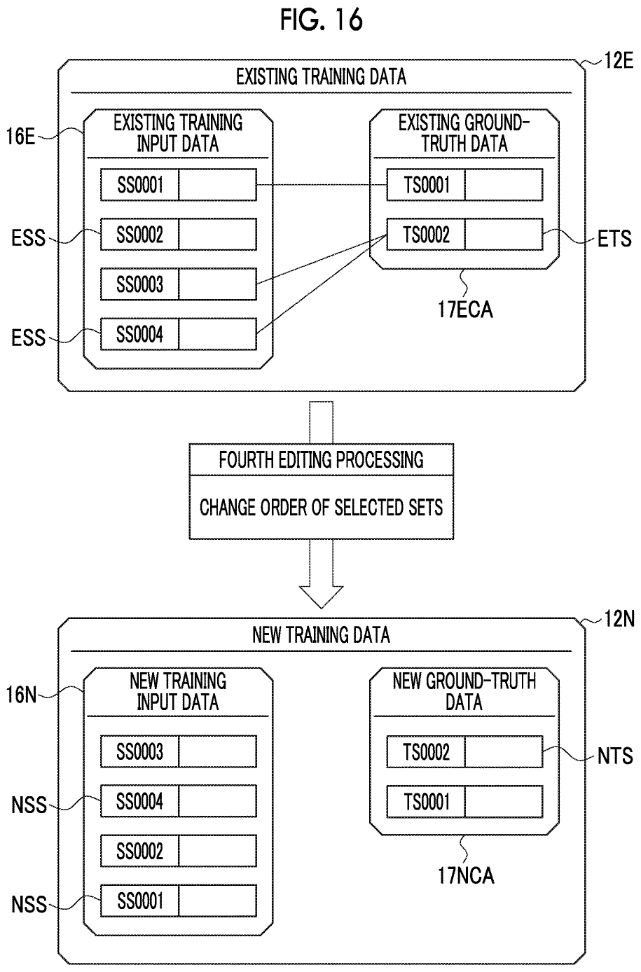

FIG. 16 shows the fourth editing processing. The fourth editing processing is processing of changing an order of the selected sets of the existing input data sentence ESS and the existing ground-truth data sentence ETS in the existing training data 12E to generate the new training data 12N.

FIG. 16 shows a case where a set of the existing input data sentence ESS having a sentence ID “SS0001” and the existing ground-truth data sentence ETS having a sentence ID “TS0001” and sets of the existing input data sentences ESS having sentence IDs “SS0003” and “SS0004” and the existing ground-truth data sentence ETS having a sentence ID “TS0002” are selected. In this case, the editing unit 39 generates the new training data 12N in which the order of the existing input data sentence ESS having the sentence IDs “SS0003” and “SS0004” and the existing ground-truth data sentence ETS having the sentence ID “TS0002” is changed first and the order of the existing input data sentence ESS having the sentence ID “SS0001” and the existing ground-truth data sentence ETS having the sentence ID “TS0001” is changed later.

The editing unit 39 performs four types of editing processing of first editing processing, second editing processing, third editing processing, and fourth editing processing on one existing training data 12E. Therefore, four pieces of new training data 12N are generated from one existing training data 12E. However, the first editing processing and the third editing processing cannot be performed on the existing training data 12E in which all the sets of the existing input data sentence ESS and the existing ground-truth data sentence ETS are selected. The first editing processing, the second editing processing, the third editing processing, and the fourth editing processing may be randomly performed, such as performing the first editing processing and the fourth editing processing on a certain existing training data 12E and performing all of the first editing processing, the second editing processing, the third editing processing, and the fourth editing processing on another existing training data 12E.

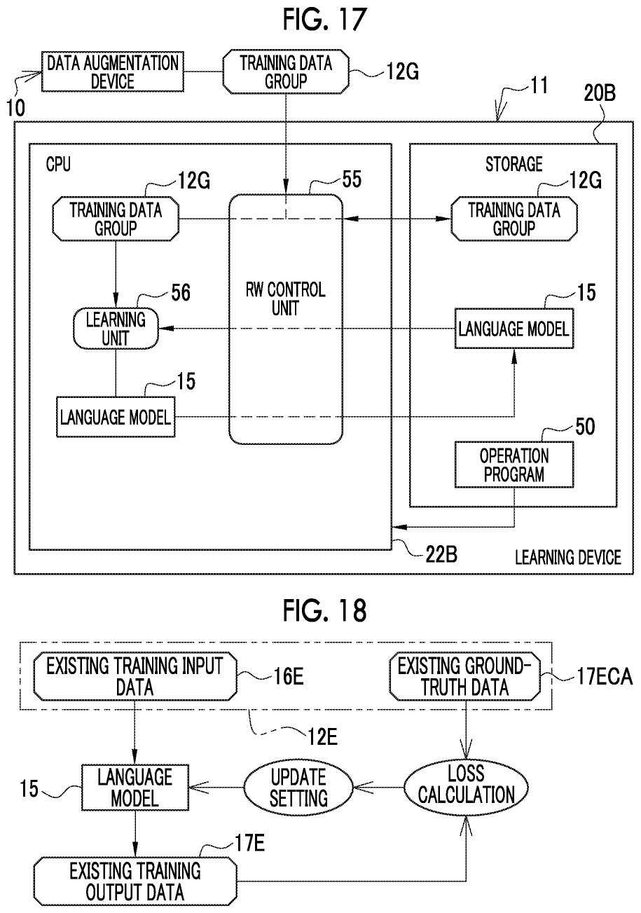

As shown in FIG. 17 as an example, the storage 20B of the learning device 11 stores an operation program 50. The operation program 50 is an application program causing the computer to function as the learning device 11. That is, the operation program 50 is an example of “an operation program of a learning support device” according to the technology of the present disclosure, together with the operation program 30. The storage 20B also stores the language model 15 and the like.

In a case in which the operation program 50 is activated, the CPU 22B of the computer constituting the learning device 11 functions as the read/write (hereinafter, referred to as RW) control unit 55 and a learning unit 56 in cooperation with the memory 21 and the like.

The RW control unit 55 controls storing of various types of data in the storage 20B and reading of various types of data from the storage 20B. For example, the RW control unit 55 stores the training data group 12G from the data augmentation device 10 in the storage 20B. In addition, the RW control unit 55 reads out the training data group 12G from the storage 20B and outputs the readout training data group 12G to the learning unit 56. Further, the RW control unit 55 reads out the language model 15 from the storage 20B and outputs the readout language model 15 to the learning unit 56. The learning unit 56 trains the language model 15 using the training data group 12G.

As shown in FIG. 18 as an example, the learning unit 56 inputs the existing training input data 16E to the language model 15 and outputs the existing training output data 17E from the language model 15. The learning unit 56 compares the existing training output data 17E with existing ground-truth data 17ECA and performs loss calculation of the language model 15 using a loss function based on a comparison result. Then, the update setting of various coefficients of the language model 15 is performed in accordance with a result of the loss calculation, and the language model 15 is updated in accordance with the update setting.

In addition, as shown in FIG. 19 as an example, the learning unit 56 inputs the new training input data 16N to the language model 15 and outputs the new training output data 17N from the language model 15. The learning unit 56 compares the new training output data 17N with new ground-truth data 17NCA and performs loss calculation of the language model 15 using a loss function based on a comparison result. Then, the update setting of various coefficients of the language model 15 is performed in accordance with a result of the loss calculation, and the language model 15 is updated in accordance with the update setting.

The learning unit 56 repeatedly performs a series of processing of input of the existing training input data 16E or the new training input data 16N to the language model 15, output of the existing training output data 17E or the new training output data 17N from the language model 15, the loss calculation, the update settings, and update of the language model 15 while exchanging the existing training data 12E or the new training data 12N. The learning unit 56 ends the repetition of the series of processing in a case where the performance of the language model 15 reaches a predetermined set level. The learning unit 56 outputs the language model 15 of which the performance reaches the set level to the RW control unit 55. The RW control unit 55 stores the language model 15 of which the performance reaches the set level in the storage 20B again as the trained language model 15. Training may be finished in a case where the series of processing is repeated a set number of times, regardless of the performance of the language model 15. Training of the language model 15 may continue even after storing the language model 15 in the storage 20B.

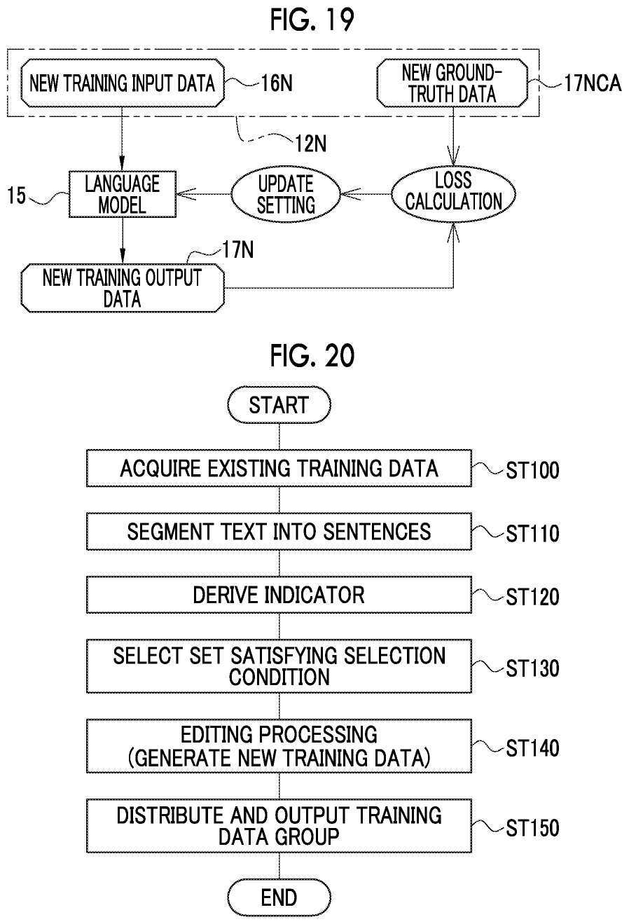

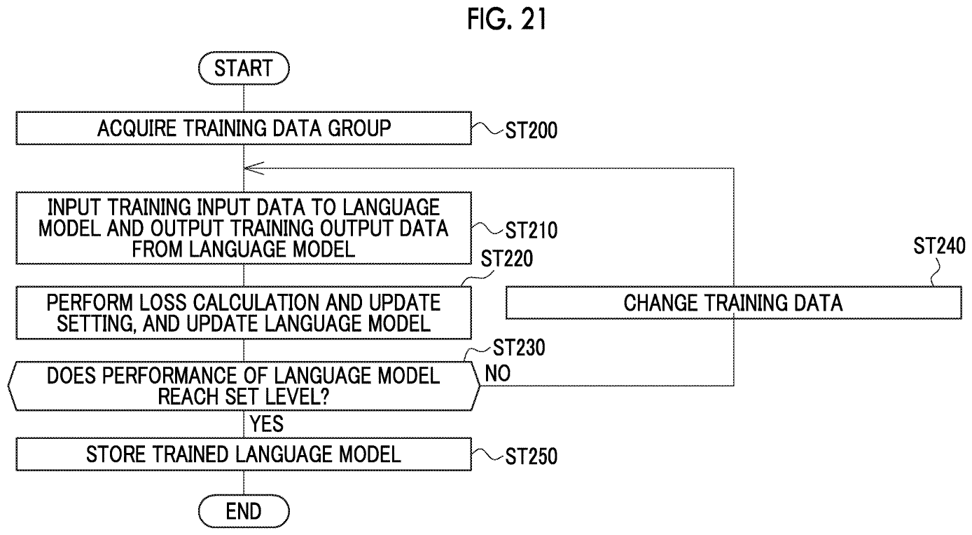

Next, an operation of the above configuration will be described with reference to flowcharts shown in FIGS. 20 and 21 as an example. As shown in FIG. 6, the CPU 22A of the data augmentation device 10 functions as the RW control unit 35, the sentence segmentation unit 36, the indicator derivation unit 37, the set selection unit 38, the editing unit 39, and the distribution control unit 40 by activating the operation program 30. In addition, as shown in FIG. 17, the CPU 22B of the learning device 11 functions as the RW control unit 55 and the learning unit 56 by activating the operation program 50.

The existing training data 12E is input to the data augmentation device 10 by the developer DV. As shown in FIG. 20, in the data augmentation device 10, the existing training data 12E is acquired by the RW control unit 35 (step ST100). The existing training data 12E is stored in the storage 20A under the control of the RW control unit 35. By repeating such processing, the storage 20A stores the existing training data group 12EG, which is a set of the existing training data 12E.

The existing training data group 12EG is read out from the storage 20A by the RW control unit 35, and the readout existing training data group 12EG is output from the RW control unit 35 to the sentence segmentation unit 36 or the like.

In the sentence segmentation unit 36, the texts of the existing training input data 16E and the existing ground-truth data 17ECA of each existing training data 12E of the existing training data group 12EG are segmented into individual sentences (step ST110). The segmentation result 45 shown in FIG. 7 is output from the sentence segmentation unit 36 to the indicator derivation unit 37.

In the indicator derivation unit 37, as shown in FIGS. 8 and 9, the indicator INX of the existing input data sentence ESS and the existing ground-truth data sentence ETS of each existing training data 12E is derived (step ST120). The derivation result 46 shown in FIG. 10 is output from the indicator derivation unit 37 to the set selection unit 38.

In the set selection unit 38, as shown in FIG. 11, a set of the existing input data sentence ESS and the existing ground-truth data sentence ETS for which the indicator INX satisfies the selection condition 31 is selected (step ST130). The selection result 47 is output from the set selection unit 38 to the editing unit 39.

In the editing unit 39, as shown in FIGS. 12 to 16, the new training data 12N is generated by performing the editing processing associated with the set of the existing input data sentence ESS and the existing ground-truth data sentence ETS registered in the selection result 47 on the existing training data 12E (step ST140). A plurality of pieces of the new training data 12N are generated. The new training data group 12NG, which is a set of the plurality of pieces of the new training data 12N, is output from the editing unit 39 to the RW control unit 35. The new training data group 12NG is stored in the storage 20A under the control of the RW control unit 35.

In a case where the distribution instruction of the training data group 12G is issued from the developer DV through the input device 25, the RW control unit 35 reads out the existing training data group 12EG and the new training data group 12NG from the storage 20A. The readout existing training data group 12EG and the read new training data group 12NG are output from the RW control unit 35 to the distribution control unit 40. The distribution control unit 40 distributes and outputs the training data group 12G composed of the existing training data group 12EG and the new training data group 12NG to the learning device 11 designated by the distribution instruction (step ST150).

As shown in FIG. 21, in the learning device 11, the training data group 12G from the data augmentation device 10 is received and acquired by the RW control unit 55 (step ST200). The training data group 12G is stored in the storage 20B under the control of the RW control unit 55.

The RW control unit 55 reads out the training data group 12G from the storage 20B, and the readout training data group 12G is output from the RW control unit 55 to the learning unit 56.

In the learning unit 56, as shown in FIG. 18, the existing training input data 16E is input to the language model 15, and the existing training output data 17E is output from the language model 15. Alternatively, as shown in FIG. 19, the new training input data 16N is input to the language model 15, and the new training output data 17N is output from the language model 15 (step ST 210).

Thereafter, the loss calculation based on the comparison result between the existing training output data 17E and the existing ground-truth data 17ECA or the comparison result between the new training output data 17N and the new ground-truth data 17NCA, the update setting of the language model 15 corresponding to the result of the loss calculation, and the update of the language model 15 according to the update setting are performed (step ST220).

The processing of steps ST210 and ST220 is repeatedly performed while the performance of the language model 15 does not reach the set level (NO in step ST230), while the training data 12 is being changed (step ST240).

In a case where the performance of the language model 15 reaches the set level (YES in step ST230), the language model 15 is output from the learning unit 56 to the RW control unit 55. Under the control of the RW control unit 55, the language model 15 from the learning unit 56 is stored in the storage 20B as the trained language model 15 (step ST250).

As described above, the CPU 22A of the data augmentation device 10 comprises the RW control unit 35, the indicator derivation unit 37, the set selection unit 38, and the editing unit 39. The RW control unit 35 acquires the existing training data 12E. The indicator derivation unit 37 derives the indicator INX representing the relationship between the existing input data sentence ESS constituting the existing training input data 16E and the existing ground-truth data sentence ETS constituting the existing ground-truth data 17ECA. The set selection unit 38 selects a set of the existing input data sentence ESS and the existing ground-truth data sentence ETS for which the indicator INX satisfies the selection condition 31. The editing unit 39 generates the new training data 12N by performing the editing processing associated with the selected set on the existing training data 12E. Since the editing processing is performed in consideration of the relationship between the existing input data sentence ESS and the existing ground-truth data sentence ETS, the new training data 12N that contributes to the improvement of the performance of the language model 15 can be generated. Therefore, it is possible to contribute to the generation of the language model 15 having higher performance than that in the related art.

As shown in FIG. 9, the indicator INX includes the surface similarity SPS between the existing input data sentence ESS and the existing ground-truth data sentence ETS and the numerical value VTC corresponding to the result of the topic classification of the existing input data sentence ESS and the existing ground-truth data sentence ETS. Therefore, it is possible to improve the validity of the indicator INX and the validity of the selection of the set of the existing input data sentence ESS and the existing ground-truth data sentence ETS satisfying the selection condition 31.

In the present example, the first constituent element is the existing input data sentence ESS, the second constituent element is the existing ground-truth data sentence ETS, and both are sentences. Therefore, it is possible to easily perform the processing such as the segmentation and the derivation of the indicator INX.

As shown in FIGS. 12 to 16, the editing unit 39 performs the first editing processing, the second editing processing, the third editing processing, and the fourth editing processing as the editing processing. The first editing processing is processing of generating the new training data 12N with only the selected set of the existing input data sentence ESS and the existing ground-truth data sentence ETS in the existing training data 12E. The second editing processing is processing of integrating the selected set of the existing input data sentence ESS and the existing ground-truth data sentence ETS in the plurality of pieces of existing training data 12E to generate the new training data 12N. The third editing processing is processing of deleting the selected set of the existing input data sentence ESS and the existing ground-truth data sentence ETS in the existing training data 12E to generate the new training data 12N. The fourth editing processing is processing of changing an order of the selected sets of the existing input data sentence ESS and the existing ground-truth data sentence ETS in the existing training data 12E to generate the new training data 12N. Therefore, new training data 12N having high diversity can be generated.

As shown in FIG. 2, the language model 15 is a model that performs a task of converting an input text into an output text of a different style, such as a text summarization task. Such a language model 15 has a very wide range of applications and is in high demand. Therefore, it is possible to contribute to the generation of the language model 15 having a wide range of applications and being in high demand.

As shown in FIG. 19, the learning unit 56 trains the language model 15 using at least the new training data 12N. Therefore, it is possible to suppress the occurrence of a problem such as overfitting caused by the shortage of the training data 12, as compared with a case where the language model 15 is trained using only the existing training data 12E.

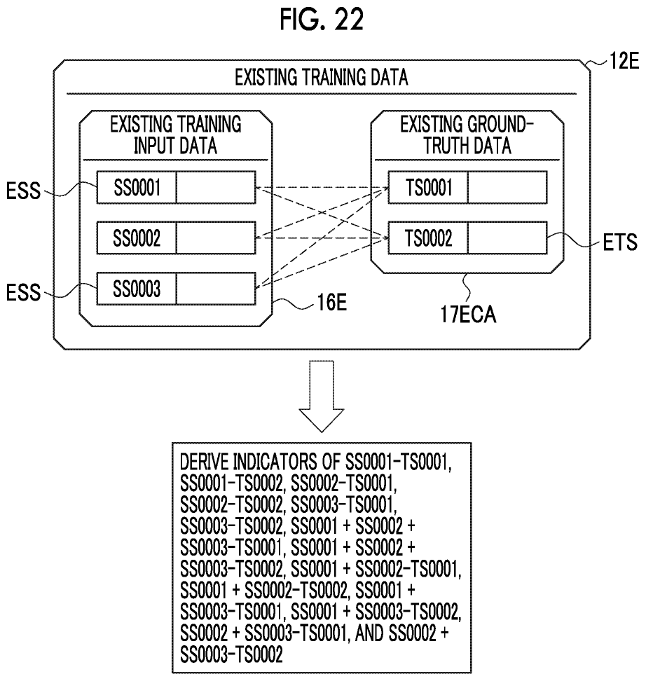

Although a set of one existing input data sentence ESS and one existing ground-truth data sentence ETS is shown as a target for deriving the indicator INX, the present disclosure is not limited thereto. As shown in FIG. 22 as an example, a set of a plurality of existing input data sentences ESS and one existing ground-truth data sentence ETS may be used as a target for deriving the indicator INX.

FIG. 22 shows a case where there are three existing input data sentences ESS having sentence IDs “SS0001” to “SS0003” and two existing ground-truth data sentences ETS having sentence IDs “TS0001” and “TS0002”. In this case, as shown in a broken line and a lower part of an arrow, the indicator derivation unit 37 derives the indicators INX of “SS0001-TS0001”, “SS0001-TS0002”, “SS0002-TS0001”, “SS0002-TS0002”, “SS0003-TS0001”, and “SS0003-TS0002”.

In addition, the indicator derivation unit 37 derives the indicators INX of “SS0001+SS0002+SS0003-TS0001” and “SS0001+SS0002+SS0003-TS0002”. Further, the indicator derivation unit 37 derives the indicators INX of “SS0001+SS0002-TS0001”, “SS0001+SS0002-TS0002”, “SS0001+SS0003-TS0001”, “SS0001+SS0003-TS0002”, “SS0002+SS0003-TS0001”, and “SS0002+SS0003-TS0002”. As a result, it is possible to generate the new training data 12N in which the relationship between the plurality of existing input data sentences ESS and the one existing ground-truth data sentence ETS is also taken into consideration.

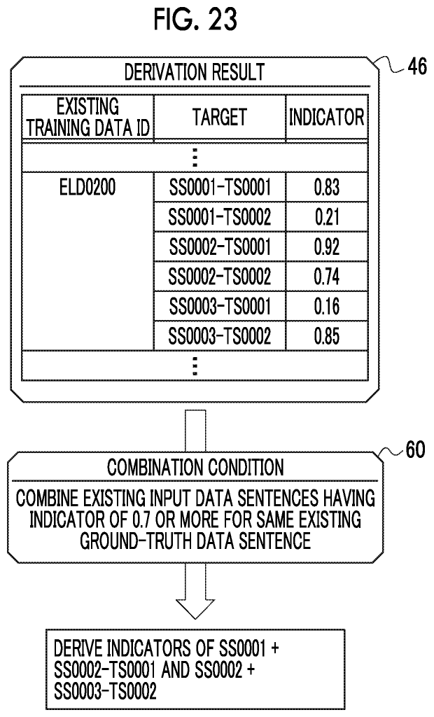

However, as shown in FIG. 22, in a case where the indicators INX of the plurality of existing input data sentences ESS and the one existing ground-truth data sentence ETS are derived in a brute-force manner, the number of targets for deriving the indicator INX may be extremely large depending on the number of the existing input data sentences ESS and the existing ground-truth data sentences ETS. Therefore, as an example, a method shown in FIG. 23 may be adopted.

As shown in FIG. 23, the indicator derivation unit 37 first derives the indicator INX of one existing input data sentence ESS and one existing ground-truth data sentence ETS, and outputs the derivation result 46. The plurality of existing input data sentences ESS to be combined as the targets for deriving the indicator INX are determined according to a preset combination condition 60. The combination condition 60 is stored in the storage 20A, and is read out from the storage 20A by the RW control unit 35 and output to the indicator derivation unit 37. The indicator derivation unit 37 derives the indicators INX of the plurality of existing input data sentences ESS determined according to the combination condition 60 and the one existing ground-truth data sentence ETS corresponding to the plurality of existing input data sentences ESS.

In FIG. 23, the combination condition 60 is combining the existing input data sentences ESS having the indicator INX of 0.7 or more for the same existing ground-truth data sentence ETS. Therefore, the indicator derivation unit 37 combines the existing input data sentences ESS having the sentence IDs “SS0001” and “SS0002” in which the indicators INX for the existing ground-truth data sentence ETS having the sentence ID “TS0001” are 0.83 and 0.92, respectively, and derives the indicator INX of “SS 0001+SS0002-TS0001”. In addition, the indicator derivation unit 37 combines the existing input data sentences ESS having the sentence IDs “SS0002” and “SS0003” in which the indicators INX for the existing ground-truth data sentence ETS having the sentence ID “TS0002” are 0.74 and 0.85, respectively, and derives the indicator INX of “SS0002+SS0003-TS0002”.

According to the method shown in FIG. 23, it is possible to narrow down the targets for deriving the indicator INX. It is possible to save time and effort for deriving the indicator INX as compared with a case where the indicators INX of the plurality of existing input data sentences ESS and the one existing ground-truth data sentence ETS are derived in a brute-force manner as shown in FIG. 22.

The method of deriving the indicator INX may be changed according to the number of the existing input data sentences ESS and the existing ground-truth data sentences ETS, such as using the method shown in FIG. 22 in a case where the total number of the existing input data sentences ESS and the existing ground-truth data sentences ETS is less than the threshold value, and using the method shown in FIG. 23 in a case where the total number of the existing input data sentences ESS and the existing ground-truth data sentences ETS is equal to or greater than the threshold value.

A set of one existing input data sentence ESS and a plurality of existing ground-truth data sentences ETS may be used as a target for deriving the indicator INX. Alternatively, a set of the plurality of existing input data sentences ESS and the plurality of existing ground-truth data sentences ETS may be a target for deriving the indicator INX.

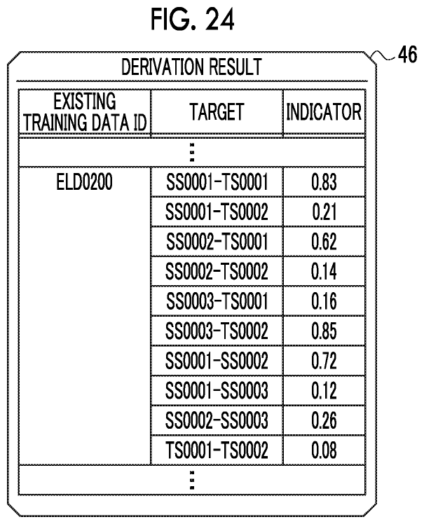

The target for deriving the indicator INX is not limited to the set of the existing input data sentence ESS and the existing ground-truth data sentence ETS. As shown in FIG. 24 as an example, the targets for deriving the indicator INX may be the existing input data sentences ESS and the existing ground-truth data sentences ETS. FIG. 24 shows a case where the indicators INX of the existing input data sentences ESS having the sentence IDs “SS0001” and “SS0002” and the existing ground-truth data sentences ETS having the sentence IDs “TS0001” and “TS0002” are derived in addition to the set of the existing input data sentence ESS having the sentence ID “SS0001” and the existing ground-truth data sentence ETS having the sentence ID “TS0001”.

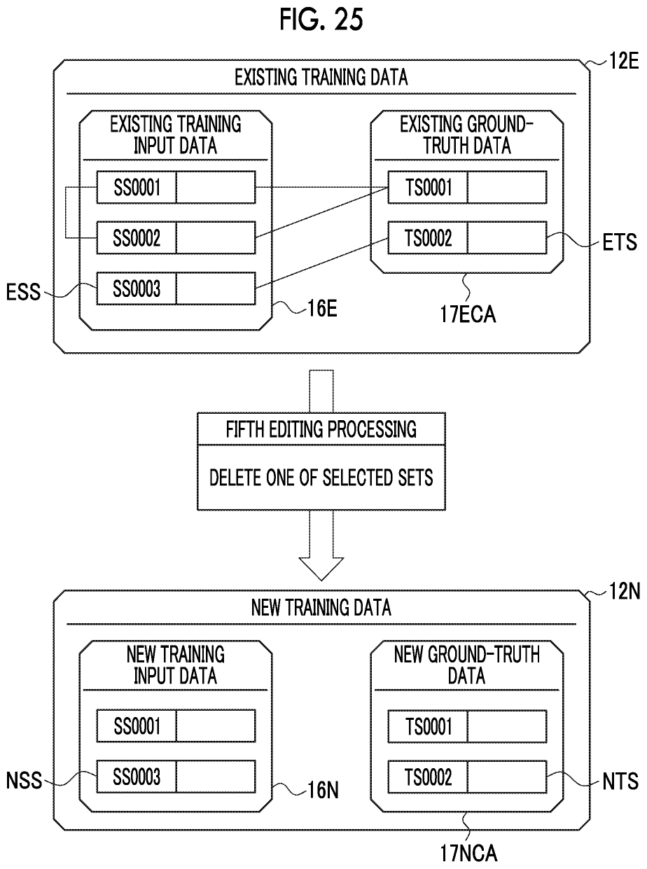

In this case, as shown in FIG. 25 as an example, the editing unit 39 performs fifth editing processing of deleting one of the set of the existing input data sentences ESS or the set of the existing ground-truth data sentences ETS, which is selected as the indicator INX satisfying the selection condition 31, as the editing processing. FIG. 25 shows a case where the existing input data sentences ESS having the sentence IDs “SS0001” and “SS0002” are selected. In this case, the editing unit 39 generates the new training data 12N by deleting the existing input data sentence ESS having the sentence ID “SS0002”, which is one of the existing input data sentences ESS having the sentence IDs “SS0001” and “SS0002”. As a result, the new training data 12N in which the relationship between the existing input data sentences ESS and the relationship between the existing ground-truth data sentences ETS are also taken into consideration can be generated. In a case where the language model 15 performs the exemplified text summarization task, the indicator INX of the existing ground-truth data sentences ETS need not be derived.

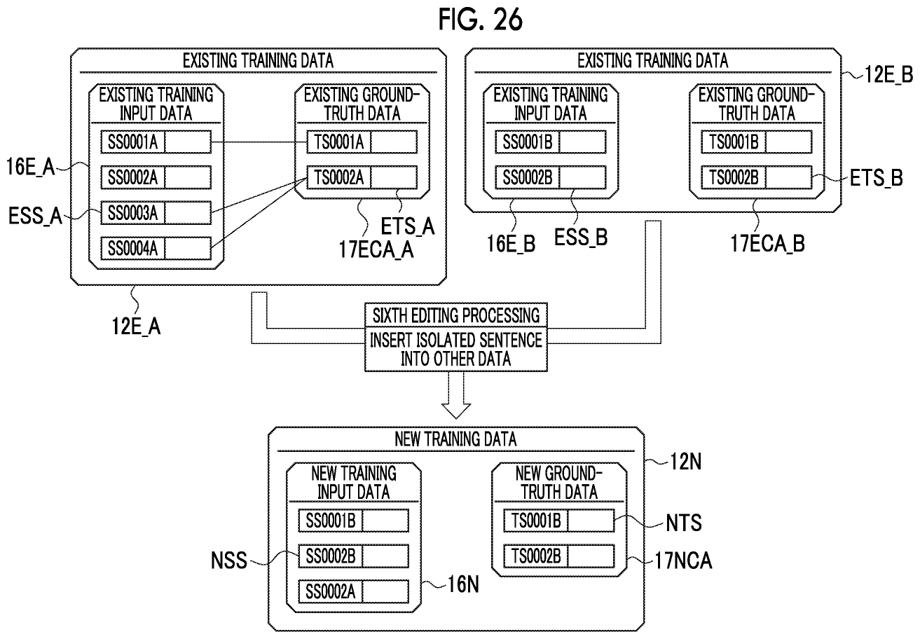

As shown in FIG. 26 as an example, the editing unit 39 may perform sixth editing processing of inserting an isolated sentence in a certain existing training data 12E into another existing training data 12E, as the editing processing. Therefore, new training data 12N having higher diversity can be generated.

FIG. 26 shows a case where the existing input data sentence ESS_A having the sentence ID “SS0002A” in the existing training input data 16E_A of the existing training data 12E_A is an isolated sentence. In this case, the editing unit 39 generates the new training data 12N by inserting the existing input data sentence ESS_A having the sentence ID “SS0002A” into the existing training input data 16E_B of the existing training data 12E_B.

The isolated sentence is likely to have little influence on the overall content of the text, such as a boilerplate sentence. Therefore, it is considered that the relationship between the existing input data sentence ESS and the existing ground-truth data sentence ETS is not broken even in a case where the isolated sentence is inserted into another existing training data 12E.

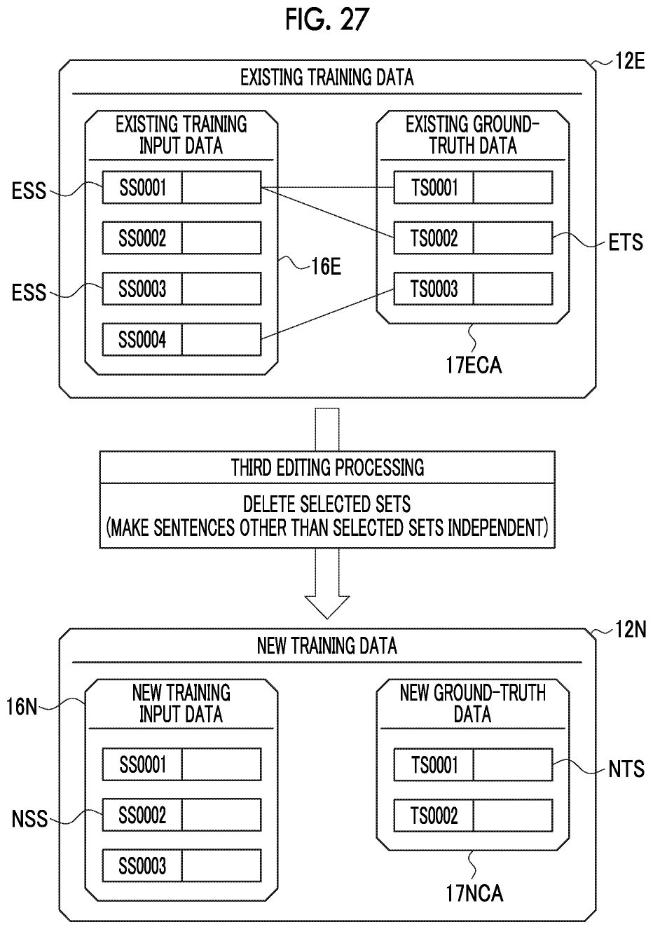

As shown in FIG. 27 as an example, in a case where there is a set of one existing input data sentence ESS and a plurality of existing ground-truth data sentences ETS satisfying the selection condition 31, the editing unit 39 generates the new training data 12N without deleting the set in the third editing processing. As a result, it is possible to avoid a situation in which the existing input data sentence ESS having a high relationship with the plurality of existing ground-truth data sentences ETS is deleted and the language model 15 cannot estimate the data corresponding to the plurality of existing ground-truth data sentences ETS.

FIG. 27 shows a case where a set of the existing input data sentence ESS having the sentence ID “SS0001” and two existing ground-truth data sentences ETS having the sentence IDs “TS0001” and “TS0002” is selected. In this case, in a case where the existing input data sentence ESS having the sentence ID “SS0001” and the existing ground-truth data sentence ETS having the sentence ID “TS0001” are deleted, a clue for estimating the sentence corresponding to the existing ground-truth data sentence ETS having the sentence ID “TS0002” is lost. Therefore, the editing unit 39 generates the new training data 12N without deleting the set of the existing input data sentence ESS having the sentence ID “SS0001” and the existing ground-truth data sentences ETS having the sentence IDs “TS0001” and “TS0002”.

It should be noted that, for the set of one existing input data sentence ESS and a plurality of existing ground-truth data sentences ETS, even in a case where the selection condition 31 is satisfied, the set may be set not to be selected in the first place by the set selection unit 38.

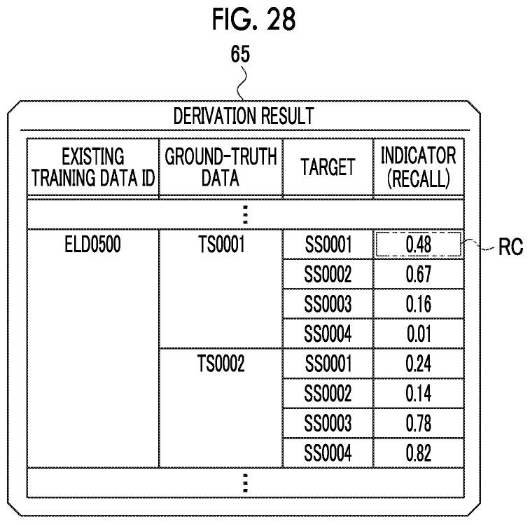

As the indicator INX, the surface similarity SPS, the semantic similarity SMS, the keyword similarity KM, the numerical value VIR corresponding to the determination result of the textual entailment, and the numerical value VTC corresponding to the result of the topic classification have been described as examples, but the present disclosure is not limited thereto. In a case where the language model 15 is a model that performs the exemplified text summarization task, as shown in a derivation result 65 shown in FIG. 28 as an example, a recall RC of the existing input data sentence ESS with respect to the existing ground-truth data sentence ETS may be derived as the indicator INX. The existing input data sentence ESS is an example of “the other of the first constituent element and the second constituent element” according to the technology of the present disclosure. The existing ground-truth data sentence ETS is an example of “one of the first constituent element and the second constituent element” according to the technology of the present disclosure. The recall RC is an example of a “coverage rate” according to the technology of the present disclosure.

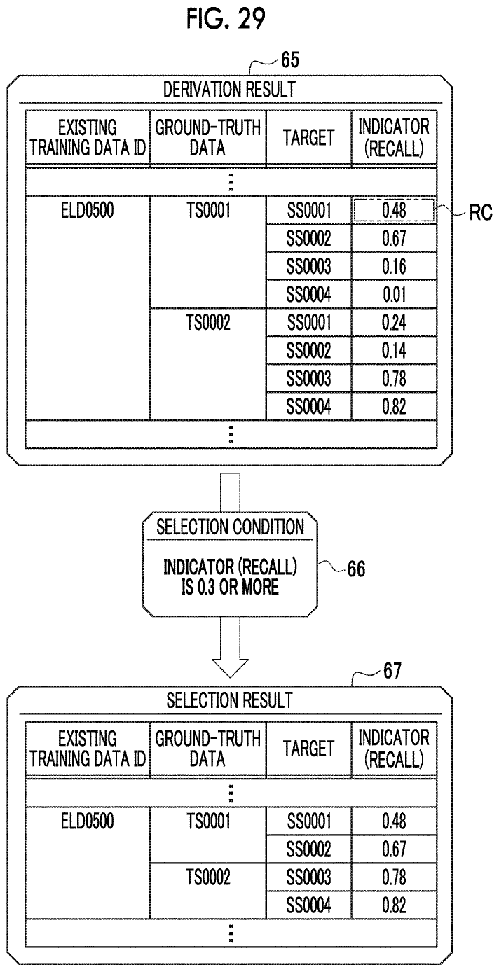

In this case, as shown in FIG. 29 as an example, the set selection unit 38 extracts the set of the existing input data sentence ESS and the existing ground-truth data sentence ETS, in which the recall RC is 0.3 or more, from the derivation result 65 in accordance with the selection condition 66 that the recall RC, which is the indicator INX, is 0.3 or more, to obtain the selection result 67.

In a case of the language model 15 that performs the text summarization task, the indicator INX such as the surface similarity SPS may misjudge the relationship between the existing input data sentence ESS and the existing ground-truth data sentence ETS. For example, in a case where the existing input data sentence ESS is “Early this morning, two robbers entered a convenience store in Shinjuku 3-chome and stole money and valuables and escaped.”, and the corresponding existing ground-truth data sentence ETS is “A robbery occurred.”, the surface similarity SPS is not so high, but the recall RC is high. In a case where the indicator INX is the recall RC, it is possible to reduce the concern that the relationship between the existing input data sentence ESS and the existing ground-truth data sentence ETS is misjudged.

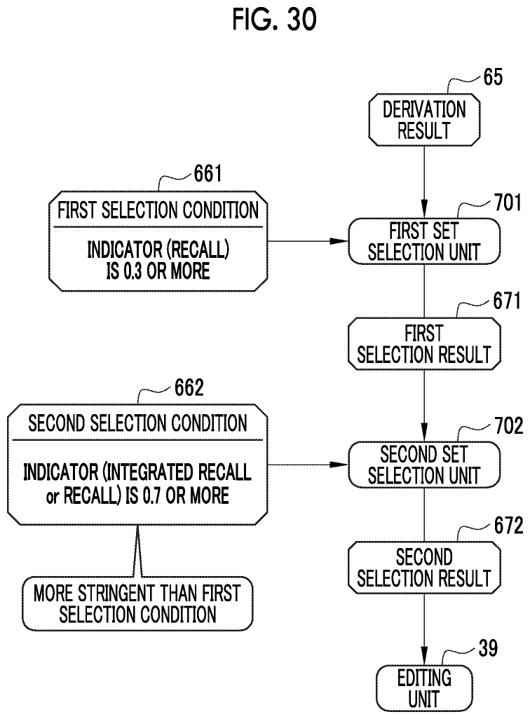

In a case where the indicator INX is the recall RC, processing shown in FIGS. 30 to 32 may be performed as an example.

In FIG. 30, a CPU of the data augmentation device according to the present aspect includes two set selection units, that is, a first set selection unit 701 and a second set selection unit 702, instead of the set selection unit 38 according to Embodiment 1. The first set selection unit 701 performs a first selection of selecting a set of the existing input data sentence ESS and the existing ground-truth data sentence ETS for which the recall RC satisfies a first selection condition 661. The first selection condition 661 is the same as the selection condition 66 shown in FIG. 29, that is, the recall RC, which is the indicator INX, is 0.3 or more. The first set selection unit 701 outputs a first selection result 671 to the second set selection unit 702.

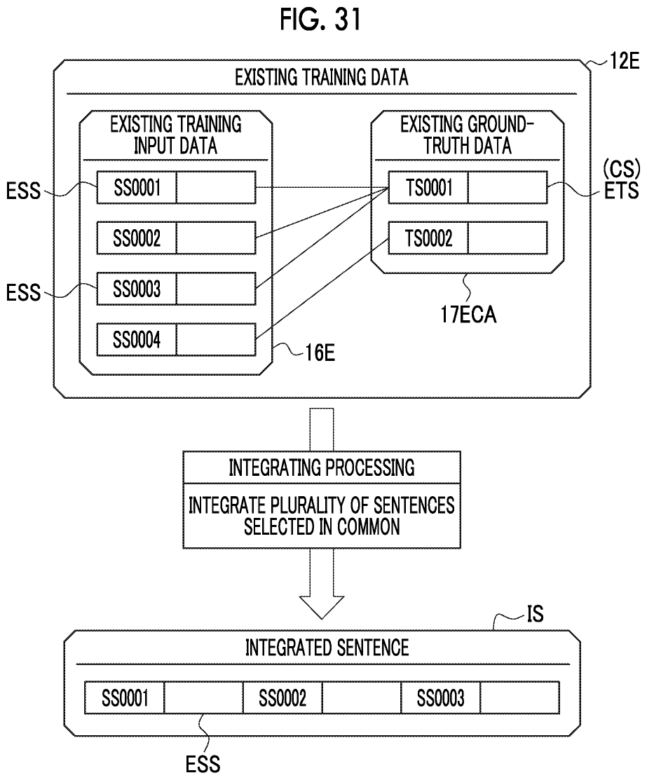

As shown in FIG. 31 as an example, in a case where there is a common sentence CS, which is the existing ground-truth data sentence ETS, that is selected in common to two or more existing input data sentences ESS, the second set selection unit 702 first performs integration processing of integrating the two or more existing input data sentences ESS to generate an integrated sentence IS. The common sentence CS is an example of a “common constituent element” according to the technology of the present disclosure. The integrated sentence IS is an example of an “integrated constituent element” according to the technology of the present disclosure.

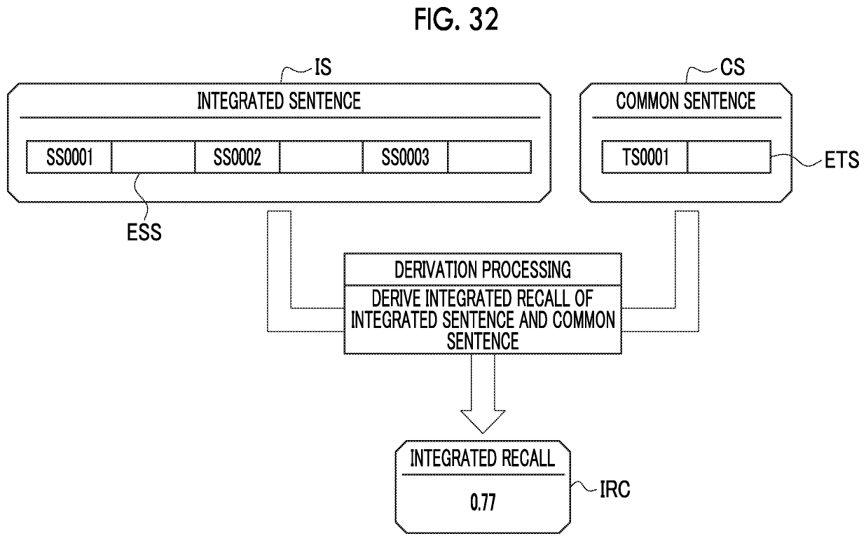

FIG. 31 shows a case where the existing input data sentences ESS having sentence IDs “SS0001”, “SS0002”, and “SS0003” are selected in common to the existing ground-truth data sentence ETS having a sentence ID “TS0001”. In this case, the existing ground-truth data sentence ETS having the sentence ID “TS0001” is the common sentence CS. The second set selection unit 702 generates the integrated sentence IS in which the existing input data sentences ESS having the sentence IDs “SS0001”, “SS0002”, and “SS0003” are connected by a coordinating conjunction (in a case of Japanese, a conjunction particle) to form one sentence. Next, as shown in FIG. 32 as an example, the second set selection unit 702 performs derivation processing of deriving an integrated recall IRC, which is a recall between the generated integrated sentence IS and the common sentence CS. The integrated recall IRC is an example of an “integrated coverage rate” according to the technology of the present disclosure.

In FIG. 30, the second set selection unit 702 selects a set of the integrated sentence IS and the common sentence CS for which the integrated recall IRC satisfies the second selection condition 662. In addition, the second set selection unit 702 also selects a set for which the recall RC satisfies the second selection condition 662 for a set of the existing input data sentence ESS and the existing ground-truth data sentence ETS (the existing input data sentence ESS having the sentence ID “SS0004” and the existing ground-truth data sentence ETS having the sentence ID “TS0002” in FIG. 31, or the like) other than the common sentence CS and the integrated sentence IS. The second selection condition 662 is more stringent than the first selection condition 661 in that the integrated recall IRC or the recall RC, which is the indicator INX, is 0.7 or more. The second set selection unit 702 outputs a second selection result 672 to the editing unit 39. For the set of the existing input data sentence ESS and the existing ground-truth data sentence ETS other than the common sentence CS and the integrated sentence IS, the first selection based on the first selection condition 661, which is looser than the second selection condition 662, is not necessary, but the first selection is necessary because the first selection is performed to extract the common sentence CS.

In this case, the editing unit 39 performs the editing processing associated with a set of one existing input data sentence ESS and one existing ground-truth data sentence ETS among the sets of the second selection results 672 selected as satisfying the second selection condition 662. In addition, the editing unit 39 also performs the editing processing associated with the set of the integrated sentence IS and the common sentence CS of the second selection result 672 selected as satisfying the second selection condition 662.

As described above, the first set selection unit 701 performs a first selection of selecting a set of the existing input data sentence ESS and the existing ground-truth data sentence ETS for which the recall satisfies the first selection condition 661. The second set selection unit 702 derives the integrated recall IRC between the common sentence CS, which is the existing ground-truth data sentence ETS selected in common to the two or more existing input data sentences ESS, and the integrated sentence IS obtained by integrating the two or more existing input data sentences ESS. The second set selection unit 702 performs the second selection of selecting the set of the existing input data sentence ESS and the existing ground-truth data sentence ETS for which the recall RC satisfies the second selection condition 662, which is more stringent than the first selection condition 661, and selecting the set of the common sentence CS and the integrated sentence IS for which the integrated recall IRC satisfies the second selection condition 662. Therefore, it is possible to prevent a sentence having a low recall RC in a case of being viewed as the integrated sentence IS from being selected as a sentence having a high relationship, although the recall RC is high in a case of being viewed one sentence at a time. It is possible to generate more appropriate new training data 12N.

In contrast to the above-described aspect, the recall RC of the existing ground-truth data sentence ETS with respect to the existing input data sentence ESS may be derived as the indicator INX. In addition, as the coverage rate, the precision may be derived instead of or in addition to the recall RC.

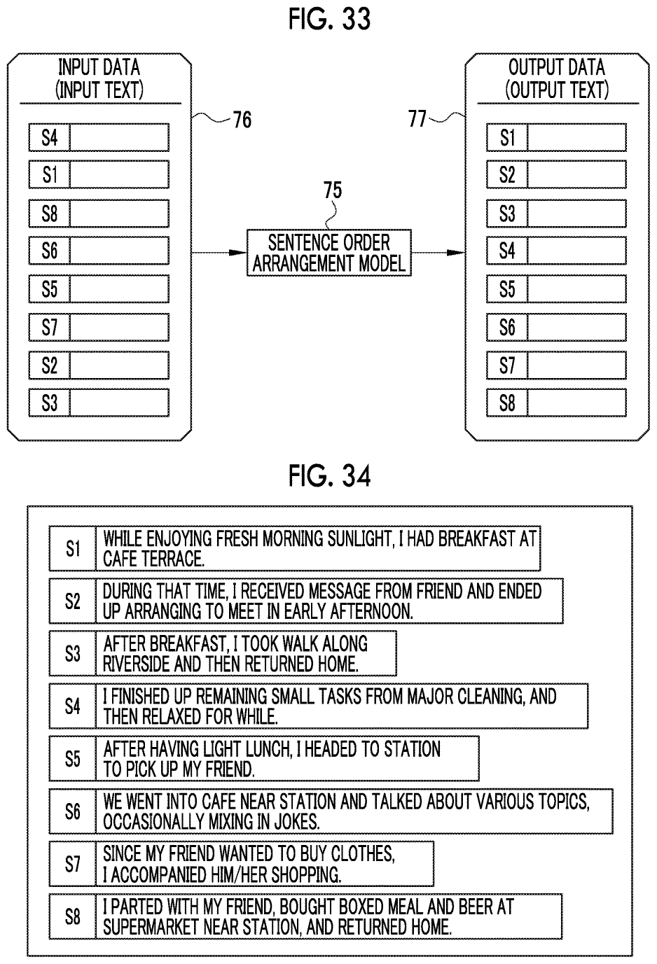

In a case where the new training data 12N is generated by performing the second editing processing and the fourth editing processing as the editing processing, it is preferable to use a sentence order arrangement model 75 shown in FIG. 33 as an example.

The sentence order arrangement model 75 is a model that performs a task of arranging the order of sentences of input data 76, which is an input text, in a normal order and outputting the input data 76 as output data 77, which is an output text. FIG. 33 shows a case where the input data 76 in which the order of sentences of a diary-like text composed of eight sentences S1 to S8 is randomly changed, as shown in FIG. 34 as an example, is input to the sentence order arrangement model 75, and the output data 77 in which the sentences are arranged in a normal order of S1 to S8 is output from the sentence order arrangement model 75.

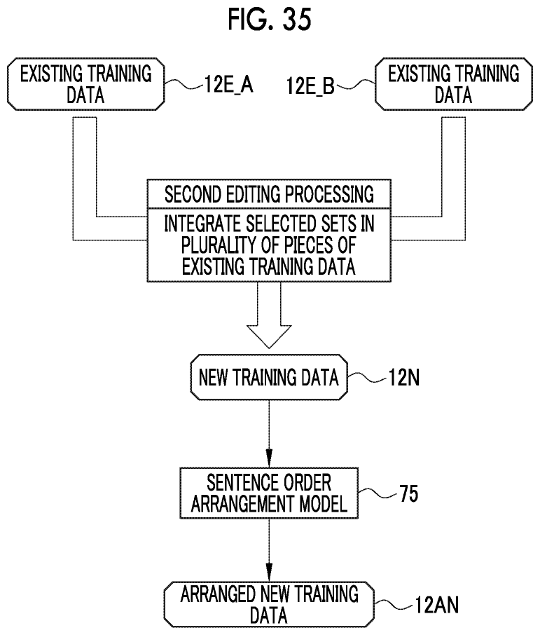

FIG. 35 shows an example in which the sentence order arrangement model 75 is applied to the new training data 12N generated by performing the second editing processing. In this case, the editing unit 39 arranges the order of new input data sentences NSS constituting the new training input data 16N of the new training data 12N in a normal order by using the sentence order arrangement model 75. In addition, the editing unit 39 arranges the order of new ground-truth data sentences NTS constituting the new ground-truth data 17NCA of the new training data 12N in a normal order by using the sentence order arrangement model 75. In this way, the editing unit 39 sets the new training data 12N as arranged new training data 12AN.

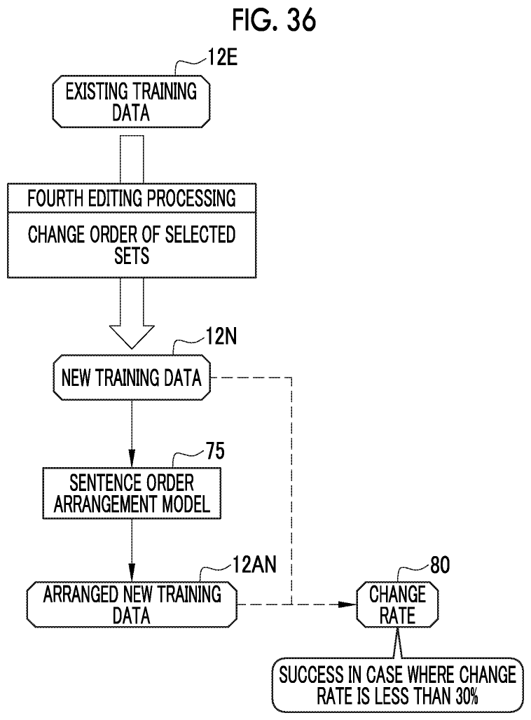

FIG. 36 shows an example in which the sentence order arrangement model 75 is applied to the new training data 12N generated by performing the fourth editing processing. In this case as well, as in the case of FIG. 35, the editing unit 39 arranges the order of the new input data sentence NSS and the new ground-truth data sentence NTS in a normal order by using the sentence order arrangement model 75, and sets the new training data 12N as the arranged new training data 12AN.

The editing unit 39 compares the new training data 12N with the arranged new training data 12AN to derive a change rate 80. The change rate 80 is a numerical value indicating how much the order of the new input data sentence NSS and the new ground-truth data sentence NTS is changed between the new training data 12N and the arranged new training data 12AN. For example, in a case where the total number of the new input data sentence NSS and the new ground-truth data sentence NTS is 20 and the total number of the new input data sentence NSS and the new ground-truth data sentence NTS of which the order is changed is 4, the change rate 80 is (4/20)×100=20%.

In a case where the change rate 80 is less than a threshold value, for example, less than 30%, the editing unit 39 determines that the order of the sentences of the new training data 12N is close to the normal order, and adopts the new training data 12N. On the other hand, in a case where the change rate 80 is equal to or greater than a threshold value, the editing unit 39 determines that the order of the sentences of the new training data 12N is far from the normal order, and does not adopt the new training data 12N.

As described above, in a case where the new training data 12N is generated by performing the second editing processing and the fourth editing processing, the editing unit 39 uses the sentence order arrangement model 75 that arranges the order of the sentences of the input text. Therefore, as shown in FIG. 35, the order of the sentences of the new training data 12N generated in the second editing processing can be easily set to the normal order. In addition, as shown in FIG. 36, it is possible to determine whether or not the order of the sentences of the new training data 12N is close to the normal order, and to adopt only the new training data 12N determined to be close to the normal order.

In the fourth editing processing, a plurality of pieces of new training data 12N having different orders of sentences are generated from one existing training data 12E. The sentence order arrangement model 75 may be applied to each of the plurality of pieces of new training data 12N to output the arranged new training data 12AN, and the change rate 80 may be further derived. In this case as well, as in the case of FIG. 36, the new training data 12N in which the change rate 80 is less than the threshold value may be adopted, or only the new training data 12N in which the change rate 80 is the lowest may be adopted.

The sentence order arrangement model 75 is applied to both the second editing processing and the fourth editing processing, but the present disclosure is not limited thereto. The editing processing to which the sentence order arrangement model 75 is applied may be at least one of the second editing processing or the fourth editing processing. In addition, in a case where the sixth editing processing of inserting the isolated sentence in a certain existing training data 12E into another existing training data 12E, which is shown in FIG. 26, is performed, the sentence order arrangement model 75 may be used to determine the insertion position of the isolated sentence.

### Embodiment 2_1

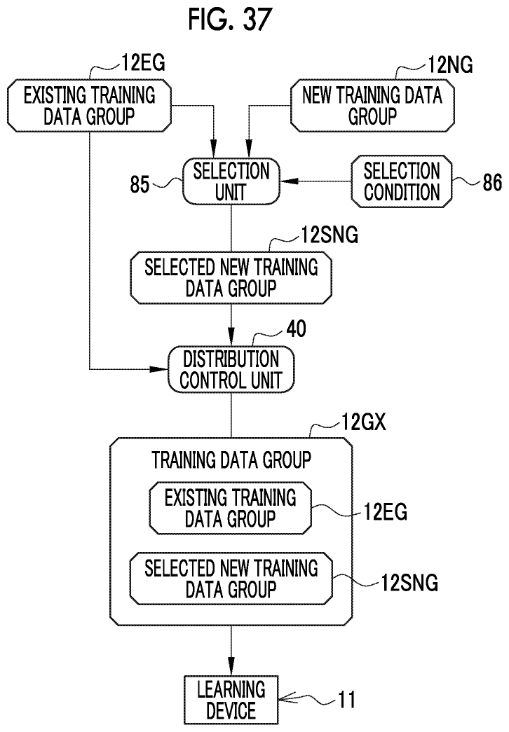

As shown in FIG. 37 as an example, a CPU of the data augmentation device of Embodiment 2_1 functions as a selection unit 85 in addition to the processing units 35 to 40 (in FIG. 37, the processing units other than the distribution control unit 40 are not shown) of Embodiment 1.

The existing training data group 12EG, the new training data group 12NG, and the selection condition 86 are input to the selection unit 85. The selection condition 86 is stored in the storage 20A, and is read out from the storage 20A by the RW control unit 35 and output to the selection unit 85. The selection unit 85 selects data to be formally adopted as the training data 12 from among the candidates for the plurality of pieces of new training data 12N constituting the new training data group 12NG in accordance with the selection condition 86. The selection unit 85 outputs a selected new training data group 12SNG, which is a set of the selected new training data 12N, to the distribution control unit 40. The distribution control unit 40 distributes and outputs the training data group 12GX composed of the existing training data group 12EG and the selected new training data group 12SNG to the learning device 11.

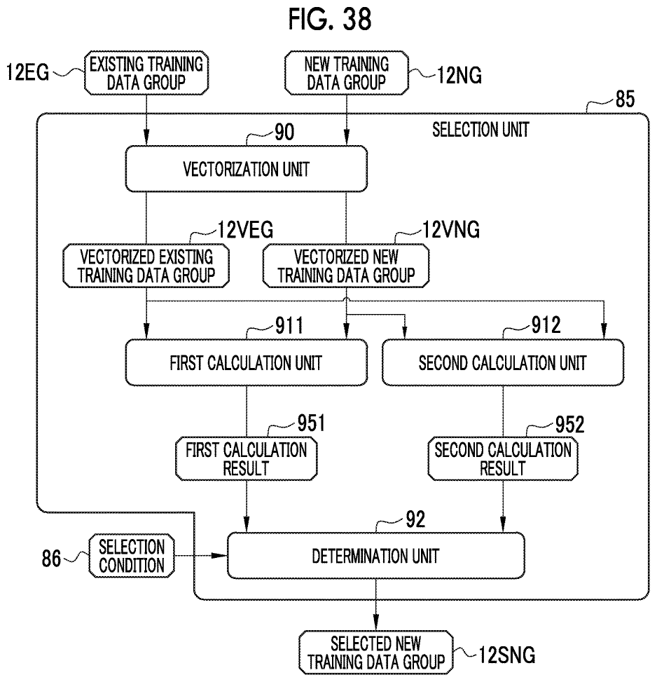

As shown in FIG. 38 as an example, the selection unit 85 includes a vectorization unit 90, a first calculation unit 911, a second calculation unit 912, and a determination unit 92. The vectorization unit 90 is, for example, a vectorization unit of a well-known language model such as BERT. The vectorization unit 90 vectorizes the existing input data sentence ESS and the existing ground-truth data sentence ETS included in each existing training data 12E of the existing training data group 12EG and the new input data sentence NSS and the new ground-truth data sentence NTS included in each new training data 12N of the new training data group 12NG. The vectorization of the sentence is processing of converting the words constituting the sentence, the order thereof, and the like into a multidimensional feature vector, for example, a 512-dimensional feature vector, which is composed of a list of a plurality of types of features. The vectorization unit 90 integrates the feature vectors of the existing input data sentence ESS and the existing ground-truth data sentence ETS into one representative feature vector. Similarly, the vectorization unit 90 integrates the feature vectors of the new input data sentence NSS and the new ground-truth data sentence NTS into one representative feature vector. The feature vector described in the following description refers to the representative feature vector. The vectorization unit 90 outputs a vectorized existing training data group 12VEG, which is the vectorized existing training data group 12EG, and a vectorized new training data group 12VNG, which is the vectorized new training data group 12NG, to the first calculation unit 911 and the second calculation unit 912.

The first calculation unit 911 calculates a first degree of deviation of each new training data 12N based on the vectorized existing training data group 12VEG and the vectorized new training data group 12VNG. The first degree of deviation is a numerical value representing a degree of deviation between the target new training data 12N and the existing training data 12E that is the source of the target new training data 12N and the new training data 12N other than the target new training data 12N. The first calculation unit 911 outputs a first calculation result 951, which is a calculation result of the first degree of deviation, to the determination unit 92. The first calculation result 951 is a result in which the first degree of deviation is registered for each new training data ID for uniquely identifying the new training data 12N.

The second calculation unit 912 calculates a second degree of deviation of each new training data 12N based on the vectorized existing training data group 12VEG and the vectorized new training data group 12VNG. The second degree of deviation is a numerical value representing a degree of deviation between the target new training data 12N and a set of the existing training data 12E. The second calculation unit 912 outputs a second calculation result 952, which is a calculation result of the second degree of deviation, to the determination unit 92. The second calculation result 952 is a result in which the second degree of deviation is registered for each new training data ID.

The determination unit 92 determines whether or not the target new training data 12N may be formally adopted as the training data 12 based on the first calculation result 951 and the second calculation result 952 in accordance with the selection condition 86. The determination unit 92 includes the new training data 12N, which is determined to be able to be formally adopted as the training data 12, in the selected new training data group 12SNG.

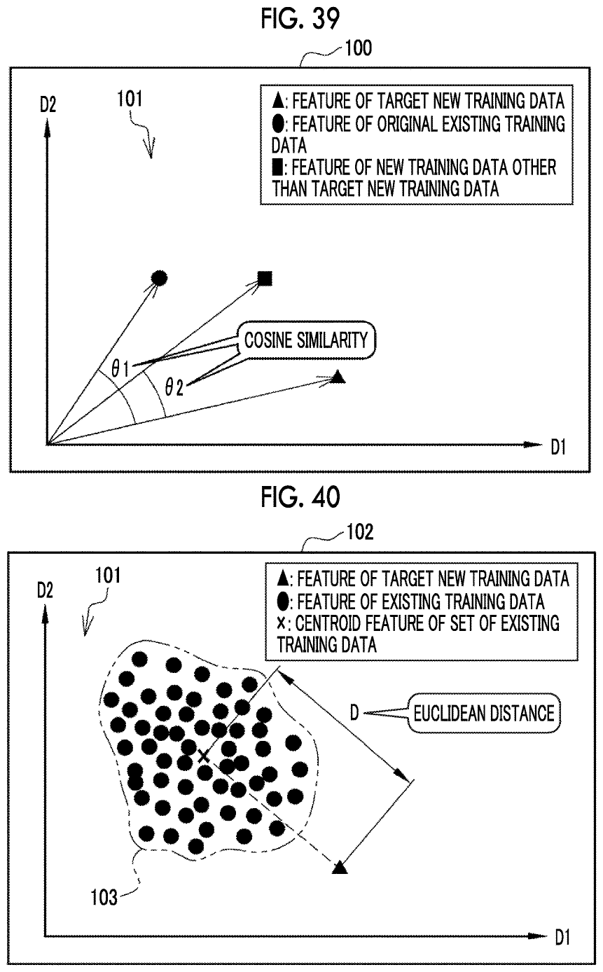

As shown in a graph 100 of FIG. 39 as an example, the first calculation unit 911 calculates a cosine similarity θ. More specifically, the first calculation unit 911 calculates a cosine similarity θ1 between a feature vector of the target new training data 12N and a feature vector of the existing training data 12E, which is the source of the target new training data 12N, in a feature vector space 101. The first calculation unit 911 calculates a cosine similarity θ2 between a feature vector of the target new training data 12N and a feature vector of the new training data 12N other than the target new training data 12N, in a feature vector space 101. Although only one cosine similarity θ2 is calculated in FIG. 39, the first calculation unit 911 actually calculates the cosine similarity θ2 for each feature vector of the plurality of pieces of new training data 12N other than the target new training data 12N. The first calculation unit 911 sets, for example, an average value θAVE of the cosine similarities θ1 and θ2 as the first degree of deviation. That is, the average value θAVE is an example of a “first degree of deviation” according to the technology of the present disclosure.

As shown in a graph 102 of FIG. 40 as an example, the second calculation unit 912 calculates a Euclidean distance D. More specifically, the second calculation unit 912 calculates the Euclidean distance D between the feature of the target new training data 12N and a centroid feature of a set 103 of the features of the existing training data 12E in the feature vector space 101. The second calculation unit 912 sets the Euclidean distance D as the second degree of deviation. That is, the Euclidean distance D is an example of a “second degree of deviation” according to the technology of the present disclosure. In addition, in FIGS. 39 and 40, for convenience of explanation, the dimensions of the feature vector space 101 are two dimensions having a D1-axis and a D2-axis. However, the actual dimensions of the feature vector space 101 are, for example, 512 dimensions as described above.

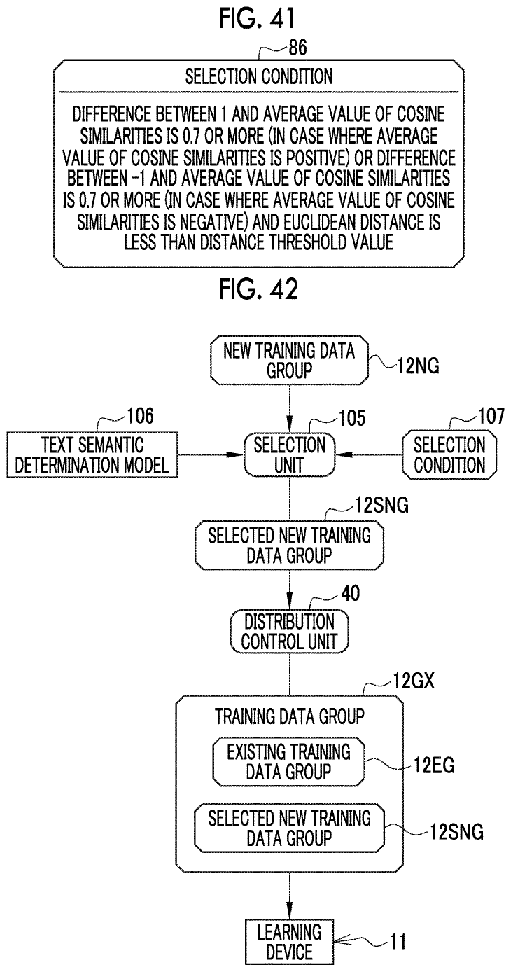

As shown in FIG. 41 as an example, the selection condition 86 is that a difference between 1 and the average value θAVE of the cosine similarities is 0.7 or more (in a case where the average value θAVE of the cosine similarities is positive), or a difference between −1 and the average value θAVE of the cosine similarities is 0.7 or more (in a case where the average value θAVE of the cosine similarities is negative), and the Euclidean distance D is less than a preset distance threshold value.

As described above, in Embodiment 2_1, the selection unit 85 selects data to be formally adopted as training data 12 from among candidates for a plurality of pieces of the new training data 12N generated by the editing processing. Therefore, it is possible to reduce a concern that the new training data 12N that is not appropriate is adopted as the training data 12.

The selection unit 85 performs the selection based on the average value θAVE of the cosine similarities, which is the first degree of deviation between target new training data 12N and the existing training data 12E, which is a source of the target new training data 12N, and new training data 12N other than the target new training data 12N, and the Euclidean distance D, which is the second degree of deviation between the target new training data 12N and a set of the existing training data 12E.

The average value θAVE of the cosine similarities, which is the first degree of deviation, represents a degree of variability of the target new training data 12N with respect to the original existing training data 12E and the other new training data 12N. In a case where there is no significant difference between the original existing training data 12E and the other new training data 12N and the target new training data 12N, there is little meaning in formally adopting the new training data 12N as the training data 12. Therefore, in Embodiment 2_1, the selection is performed based on the average value θAVE of the cosine similarities, which is the first degree of deviation, and the new training data 12N that is not significantly different from the original existing training data 12E and the other new training data 12N is excluded not to be formally adopted.

Meanwhile, the Euclidean distance D, which is the second degree of deviation, represents a degree of validity of the target new training data 12N with respect to the existing training data 12E. Even in a case where the existing training data 12E and the target new training data 12N are too similar, it is not preferable from the viewpoint of the above-described variability. However, even in a case where there is a significant difference between the existing training data 12E and the target new training data 12N, it is not preferable from the viewpoint of the validity. Therefore, in Embodiment 2_1, the selection is performed based on the Euclidean distance D, which is the second degree of deviation, and the new training data 12N that is significantly different from the existing training data 12E is excluded not to be formally adopted. In summary, according to Embodiment 2_1, it is possible to select more appropriate new training data 12N as the training data 12 to be formally adopted.

It should be noted that, as the first degree of deviation, the Euclidean distance D or the Mahalanobis distance may be calculated instead of the cosine similarity θ. Similarly, as the second degree of deviation, the Mahalanobis distance or the cosine similarity θ may be calculated instead of the Euclidean distance D.

### Embodiment 2_2

As shown in FIG. 42 as an example, a CPU of the data augmentation device of Embodiment 2_2 functions as a selection unit 105 in addition to the processing units 35 to 40 (in FIG. 42, the processing units other than the distribution control unit 40 are not shown) of Embodiment 1.

A new training data group 12NG, a text semantic determination model 106, and a selection condition 107 are input to the selection unit 105. The text semantic determination model 106 and the selection condition 107 are stored in the storage 20A, and are read out from the storage 20A by the RW control unit 35 and output to the selection unit 105. The selection unit 105 selects data to be formally adopted as the training data 12 from among the candidates for the plurality of pieces of new training data 12N constituting the new training data group 12NG by using the text semantic determination model 106 and in accordance with the selection condition 107. The selection unit 105 outputs a selected new training data group 12SNG, which is a set of the selected new training data 12N, to the distribution control unit 40. The distribution control unit 40 distributes and outputs the training data group 12GX composed of the existing training data group 12EG and the selected new training data group 12SNG to the learning device 11.

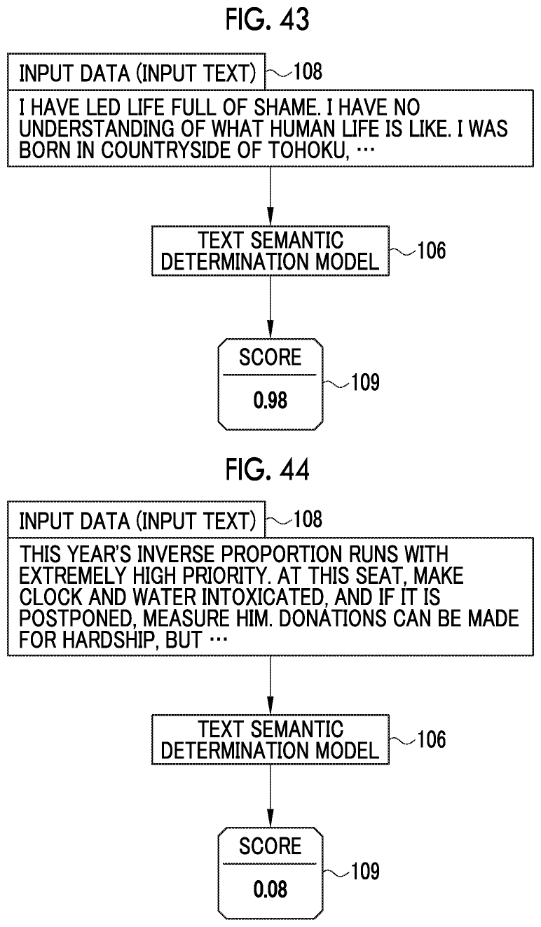

As shown in FIGS. 43 and 44 as an example, the text semantic determination model 106 is a machine learning model that outputs a score 109 representing the semantic clarity of input data 108, which is an input text. The score 109 takes a value between 0 and 1. As shown in FIG. 43, in a case where the input data 108 is a meaningful text, the text semantic determination model 106 outputs the score 109 close to 1. On the other hand, as shown in FIG. 44, in a case where the input data 108 is a text without meaning, the text semantic determination model 106 outputs the score 109 close to 0.

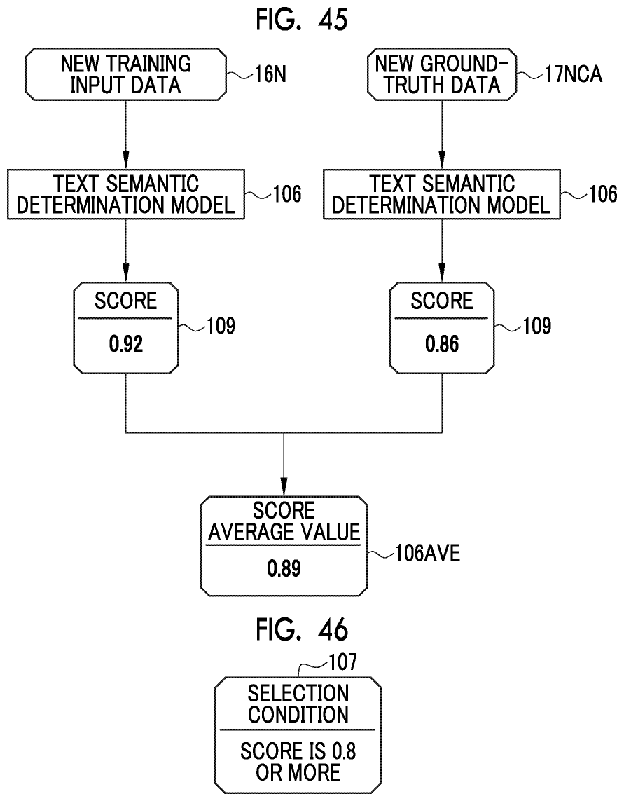

As shown in FIG. 45 as an example, the selection unit 105 inputs each of new training input data 16N and new ground-truth data 17NCA of a plurality of pieces of new training data 12N constituting the new training data group 12NG to the text semantic determination model 106 as the input data 108. The text semantic determination model 106 outputs the score 109. The selection unit 105 calculates an arithmetic mean of the score 109 of the new training input data 16N and the score 109 of the new ground-truth data 17NCA, and sets the arithmetic mean as a score average value 109AVE of the new training data 12N to be compared with the selection condition 107. The selection unit 105 calculates the score average value 109AVE of each of the plurality of pieces of new training data 12N. FIG. 45 shows a case where the score 109 of the new training input data 16N is 0.92, the score 109 of the new ground-truth data 17NCA is 0.86, and the score average value 109AVE is 0.89.

As shown in FIG. 46 as an example, the selection condition 107 is, for example, that the score average value 109AVE is 0.8 or more. Therefore, the new training data 12N in the example shown in FIG. 45 is selected as data to be formally adopted by the selection unit 105.

As described above, in Embodiment 2_2, the selection unit 105 performs the selection using the text semantic determination model 106 that outputs the score 109 representing the semantic clarity of the input data 108, which is the input text. Therefore, it is possible to reduce a concern that the new training data 12N including a meaningless text is selected, which hinders the training of the language model 15.

Embodiment 2_1 and Embodiment 2_2 may be carried out in combination. For example, Embodiment 2_1 may be carried out first to narrow down the new training data 12N, and then Embodiment 2_2 may be carried out to further narrow down the new training data 12N. In addition, the new training data 12N to be formally adopted may be randomly selected without carrying out Embodiment 2_1 and/or Embodiment 2_2.

### Embodiment 3_1

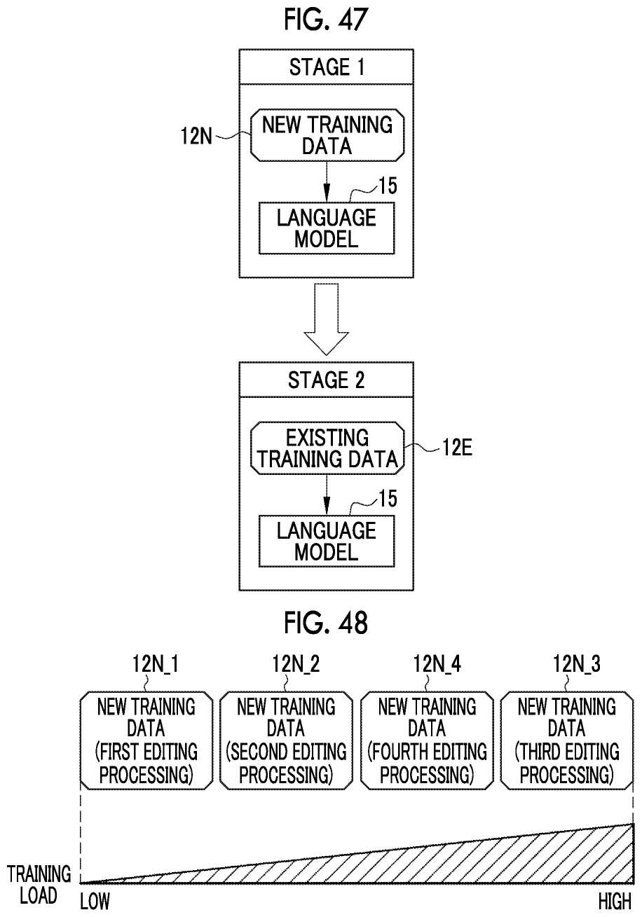

In Embodiment 3_1, an order of providing the existing training data 12E and the new training data 12N to the language model 15 in the training phase is defined. That is, as shown in FIG. 47 as an example, the learning unit 56 provides the new training data 12N to the language model 15 in Stage 1 of the training phase, and provides the existing training data 12E to the language model 15 in Stage 2 after Stage 1.

As described above, in Embodiment 3_1, the learning unit 56 trains the language model 15 using the new training data 12N, and then trains the language model 15 using the existing training data 12E. Since the new training data 12N is generated by processing the existing training data 12E, the quality of the new training data 12N is lower than the quality of the existing training data 12E. Therefore, the language model 15 is trained using the new training data 12N having relatively poor quality at first, the performance of the language model 15 is improved to some extent, and then the language model 15 is trained using the existing training data 12E having relatively good quality, so that the performance of the language model 15 can be further improved.

### Embodiment 3_2

As shown in FIG. 48 as an example, the new training data 12N is classified into new training data 12N_1 generated by the first editing processing, new training data 12N_2 generated by the second editing processing, new training data 12N_3 generated by the third editing processing, and new training data 12N_4 generated by the fourth editing processing.

Among the new training data 12N_1 to 12N_4, the new training data 12N_1 generated by the first editing processing has the lowest training load for the language model 15. The new training data 12N_2 generated by the second editing processing has the next lowest training load for the language model 15, and the new training data 12N_4 generated by the fourth editing processing has the next lowest training load thereafter for the language model 15. The new training data 12N_3 generated by the third editing processing has the highest training load for the language model 15.

As shown in FIGS. 12 and 13, the new training data 12N_1 generated by the first editing processing is generated by only the selected set of the existing input data sentence ESS and the existing ground-truth data sentence ETS in the existing training data 12E. That is, the selected sets of the existing input data sentence ESS and the existing ground-truth data sentence ETS remain in the new training data 12N_1. In addition, the plurality of pieces of existing training data 12E are not integrated as in the second editing processing, or the order of the selected sets of the existing input data sentence ESS and the existing ground-truth data sentence ETS is not changed as in the fourth editing processing. Therefore, it can be said that the training load for the language model 15 is the lowest. In addition, as shown in FIG. 14, the new training data 12N_2 generated by the second editing processing is generated by integrating the selected sets of the existing input data sentence ESS and the existing ground-truth data sentence ETS in the plurality of pieces of existing training data 12E. That is, as in the new training data 12N_1, the selected sets of the existing input data sentence ESS and the existing ground-truth data sentence ETS remain in the new training data 12N_2. In addition, the order of the selected sets of the existing input data sentence ESS and the existing ground-truth data sentence ETS is not changed as in the fourth editing processing. Therefore, it can be said that the training load for the language model 15 is the second lowest.

As shown in FIG. 16, the new training data 12N_4 generated by the fourth editing processing is generated by changing the order of the selected sets of the existing input data sentence ESS and the existing ground-truth data sentence ETS in the existing training data 12E. Therefore, the selected sets of the existing input data sentence ESS and the existing ground-truth data sentence ETS remain in the new training data 12N_4, but the prediction is difficult because the order is changed. Therefore, it can be said that the training load for the language model 15 is the third lowest. In addition, as shown in FIG. 15, the new training data 12N_3 generated by the third editing processing is generated by deleting the selected sets of the existing input data sentence ESS and the existing ground-truth data sentence ETS in the existing training data 12E. Therefore, the selected sets of the existing input data sentence ESS and the existing ground-truth data sentence ETS do not remain in the new training data 12N_3 unlike the new training data 12N_1 or the like. Therefore, it can be said that the training load for the language model 15 is the highest. In general, it can be said that the new training data 12N having a relatively low training load is data in which the selected sets of the existing input data sentence ESS and the existing ground-truth data sentence ETS remain and the processing such as integrating the plurality of pieces of existing training data 12E or changing the order of the selected sets of the existing input data sentence ESS and the existing ground-truth data sentence ETS is not performed. In other words, it can be said that the new training data 12N having a relatively low training load is data in which the relationship between the existing input data sentence ESS and the existing ground-truth data sentence ETS in the existing training data 12E is maintained.

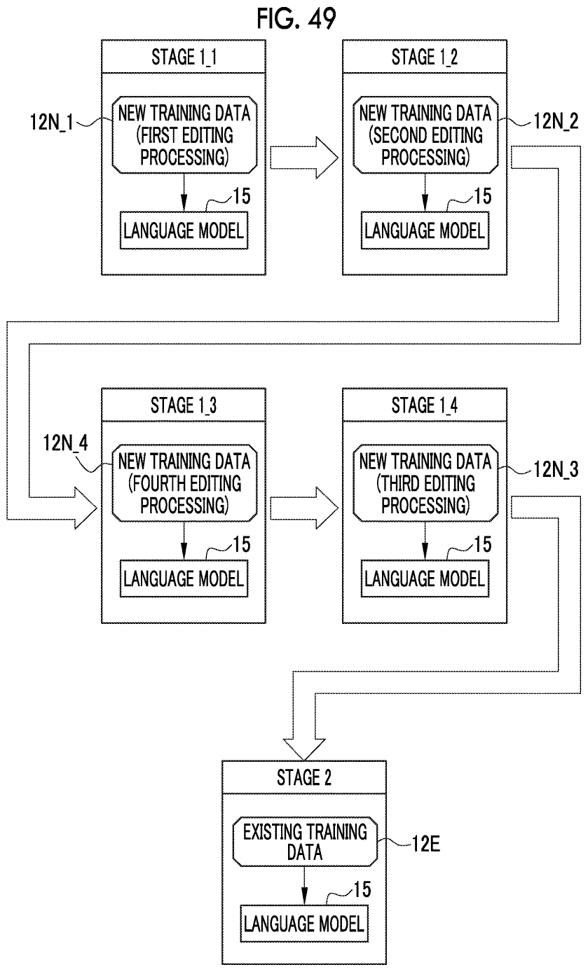

As shown in FIG. 49 as an example, the learning unit 56 trains the language model 15 by providing the new training data 12N_1 to 12N_4 in a stepwise manner. In addition, the learning unit 56 trains the language model 15 by providing the new training data 12N to the language model 15 in order from new training data 12N having a relatively low training load. That is, the learning unit 56 provides the new training data 12N_1 to the language model 15 in Stage 1_1 of the training phase, and provides the new training data 12N_2 to the language model 15 in Stage 1_2. Next, the learning unit 56 provides the new training data 12N_4 to the language model 15 in Stage 1_3, and provides the new training data 12N_3 to the language model 15 in Stage 1_4. Finally, the learning unit 56 provides the existing training data 12E to the language model 15 in Stage 2.

As described above, in Embodiment 3_2, the learning unit 56 trains the language model 15 by providing the new training data 12N_1 to 12N_4 generated for each of the first to fourth editing processing in a stepwise manner. Therefore, the language model 15 can be trained by providing the new training data 12N generated by one editing processing in a concentrated manner. The performance of the language model 15 can be further improved as compared with a case where the new training data 12N_1 to 12N_4 are provided in a random manner for training.

In addition, in Embodiment 3_2, the learning unit 56 trains the language model 15 by providing the new training data 12N to the language model 15 in order from new training data 12N having a relatively low training load. Therefore, the language model 15 can be gradually leveled up. The performance of the language model 15 can be further improved as compared with a case where the new training data 12N is provided to the language model 15 for training in order from new training data 12N having a relatively high training load.

The language model 15 may be trained using only the new training data 12N without using the existing training data 12E.

### Embodiment 4

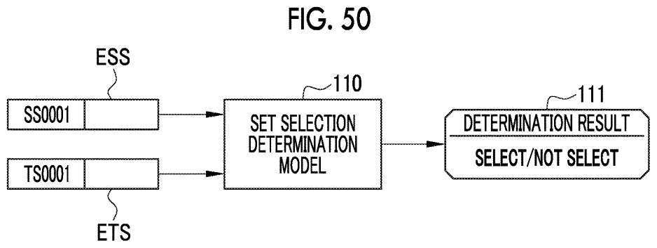

As shown in FIG. 50 as an example, in Embodiment 4, the set selection unit 38 selects a set of the existing input data sentence ESS and the existing ground-truth data sentence ETS by using the set selection determination model 110.

The set selection determination model 110 outputs a determination result 111 in response to the input of the set of the existing input data sentence ESS and the existing ground-truth data sentence ETS to be determined. The determination result 111 is selecting or not selecting the set of the existing input data sentence ESS and the existing ground-truth data sentence ETS to be determined. The set selection unit 38 outputs the determination result 111 to the editing unit 39.

The set selection determination model 110 is a machine learning model, and outputs, for example, a numerical value between 0 and 1 as a stage before outputting the determination result 111. In a case where the numerical value is equal to or greater than a preset determination threshold value (for example, 0.5), the set selection determination model 110 outputs the determination result 111 of “select”. On the other hand, in a case where the numerical value is less than the determination threshold value, the set selection determination model 110 outputs the determination result 111 of “not select”. The numerical value between 0 and 1 output in the stage before outputting the determination result 111 is an example of an “indicator” according to the technology of the present disclosure. In addition, the determination threshold value is an example of a “preset condition” according to the technology of the present disclosure.

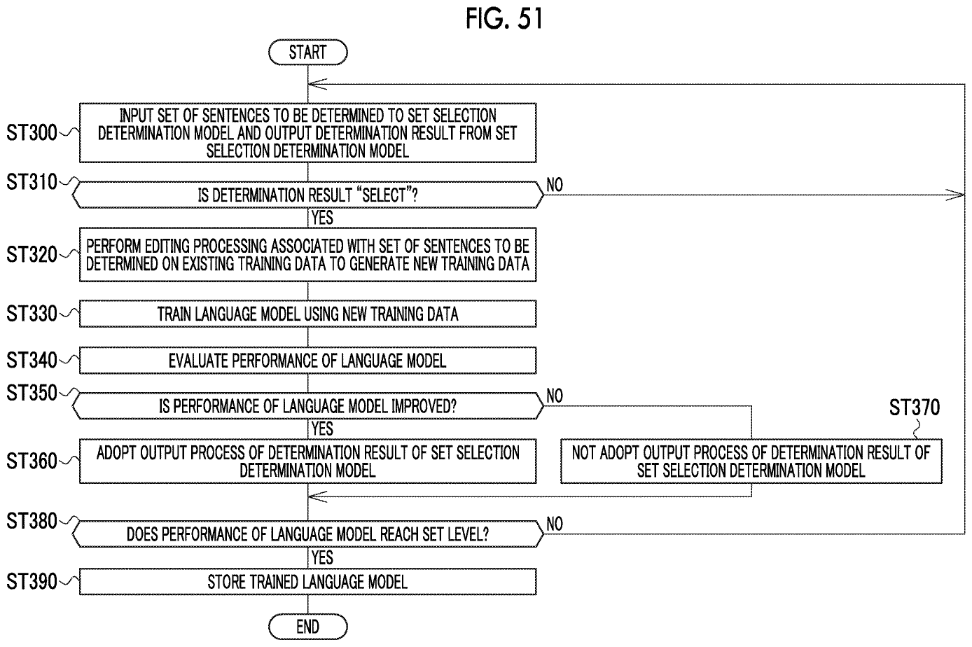

As shown in FIG. 51 as an example, in Embodiment 4, first, as shown in FIG. 50, in the set selection unit 38, the set of the existing input data sentence ESS and the existing ground-truth data sentence ETS to be determined is input to the set selection determination model 110, and the determination result 111 is output from the set selection determination model 110 (step ST300).

In a case where the determination result 111 is “select” (YES in step ST310), in the editing unit 39, the new training data 12N is generated by performing the editing processing associated with the set of the existing input data sentence ESS and the existing ground-truth data sentence ETS to be determined on the existing training data 12E (step ST320). On the other hand, in a case where the determination result 111 is “not select” (NO in step ST310), the process returns to step ST300.

Subsequently, in the learning unit 56, the language model 15 is trained by using the new training data 12N generated in step ST320 (step ST330). Thereafter, the performance of the language model 15 is evaluated (step ST340).

In a case where the performance of the language model 15 is improved as compared with before the training using the new training data 12N in step ST330 (YES in step ST350), in the learning unit 56, the output process of the determination result 111 of the set selection determination model 110 in step ST300 is adopted (step ST360). On the other hand, in a case where the performance of the language model 15 deteriorates as compared with before the training using the new training data 12N in step ST330 (NO in step ST350), in the learning unit 56, the output process of the determination result 111 of the set selection determination model 110 in step ST300 is not adopted (step ST370). The processes of step ST300 to step ST360 or step ST370 are repeatedly performed until the performance of the language model 15 reaches the set level (NO in step ST380).

In a case where the performance of the language model 15 reaches the set level (YES in step ST380), the language model 15 is output from the learning unit 56 to the RW control unit 55. Under the control of the RW control unit 55, the language model 15 from the learning unit 56 is stored in the storage 20B as the trained language model 15 (step ST 390).

As described above, in Embodiment 4, the set selection unit 38 determines whether or not to select a set of the existing input data sentence ESS and the existing ground-truth data sentence ETS to be determined by using the set selection determination model 110. In a case where the determination result 111 of the set selection determination model 110 is “select”, the editing unit 39 generates the new training data 12N by performing the editing processing associated with the set of the existing input data sentence ESS and the existing ground-truth data sentence ETS to be determined on the existing training data 12E. In a case where the performance of the language model 15 is improved as compared with before the training using the new training data 12N, the learning unit 56 adopts the output process of the determination result 111 of the set selection determination model 110. On the other hand, in a case where the performance of the language model 15 deteriorates as compared with before the training using the new training data 12N, the learning unit 56 does not adopt the output process of the determination result 111 of the set selection determination model 110.

In a case where the determination of whether or not to adopt the output process of the determination result 111 of the set selection determination model 110 is repeated based on whether or not the performance of the language model 15 is improved, the determination performance of the set selection determination model 110 can be gradually improved. Finally, the set selection determination model 110 capable of accurately selecting the set of the existing input data sentence ESS and the existing ground-truth data sentence ETS having a relatively high relationship can be obtained. The derivation processing of the complicated indicator INX, such as the surface similarity SPS of Embodiment 1, can be omitted, and the processing load of the CPU 22A can be significantly reduced.

The set input to the set selection determination model 110 is not limited to the exemplified set of one existing input data sentence ESS and one existing ground-truth data sentence ETS. The set may be a set of a plurality of existing input data sentences ESS and one existing ground-truth data sentence ETS, or a set of one existing input data sentence ESS and a plurality of existing ground-truth data sentences ETS, as shown in FIG. 22. In addition, the set may be a set of the existing input data sentences ESS or a set of the existing ground-truth data sentences ETS, as shown in FIG. 24.

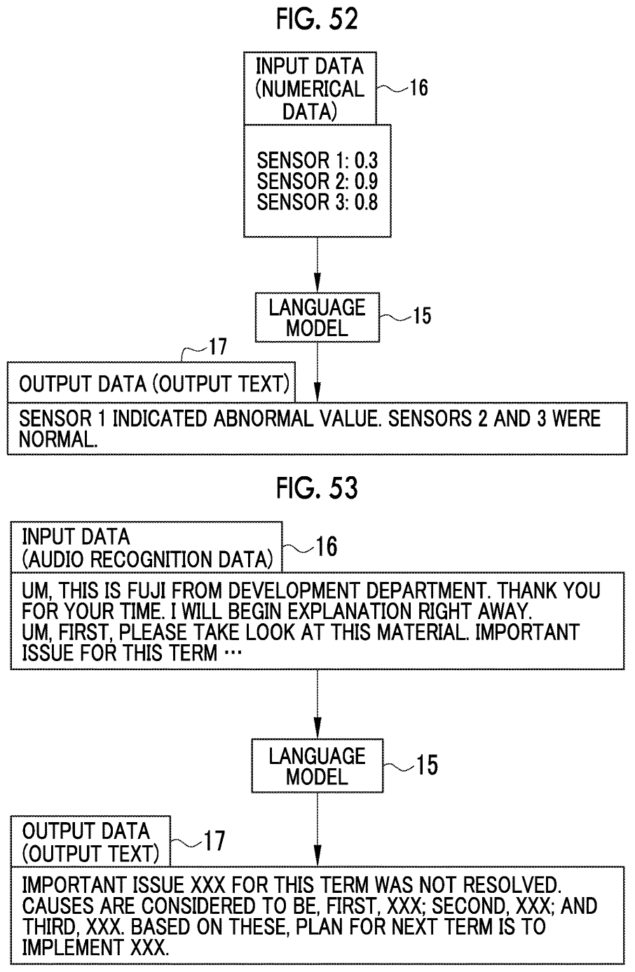

In each of the above-described embodiments, a case where both the input data 16 and the output data 17 are texts has been described as an example, but the present disclosure is not limited thereto. As shown in FIG. 52 as an example, the input data 16 may be numerical data composed of a list of output values of some sensors, and the output data 17 may be a text describing whether the output values of the sensors are normal or abnormal. In this case, the first constituent element is a list of output values of the sensors.

In addition, as shown in FIG. 53 as an example, the input data 16 may be audio recognition data obtained by recognizing spoken voice of a conference participant and transcribing the spoken voice, and the output data 17 may be a text of minutes summarizing the spoken voice. Further, in contrast to the example of FIG. 53, the input data 16 may be a text such as a draft of a presentation of a conference, and the output data 17 may be audio data such as spoken voice by artificial intelligence.

The first constituent element and the second constituent element are not limited to the exemplified sentences. The first constituent element and the second constituent element may be a text constituting one paragraph or a text constituting one page. In addition, the first constituent element and the second constituent element may be a text having the same date of description, a text having the same author, or a text having the same character style such as character size and color. Further, the first constituent element and the second constituent element may be a text divided by a specific delimiter such as #.

The task performed by the language model 15 may be a translation task. In addition, a plurality of documents may be used as the input data 16, and a summary of the plurality of documents may be used as the output data 17. Examples of the plurality of documents include a plurality of factory maintenance reports. In addition, examples of the plurality of documents include a plurality of electronic medical records of one patient, and examples of the summary include a discharge summary of the patient. In a case where the plurality of documents are used as the input data 16, the first constituent element may be one document.

The hardware configuration of the computer constituting the data augmentation device 10 and the learning device 11 according to the technology of the present disclosure can be modified in various ways. For example, the data augmentation device 10 may be configured by a plurality of computers separated as hardware in order to improve processing capacity and reliability. For example, the functions of the sentence segmentation unit 36 and the indicator derivation unit 37 and the functions of the set selection unit 38 and the editing unit 39 are distributed to two computers. In this case, the data augmentation device 10 is configured by the two computers.

In this way, the hardware configuration of the computer of the data augmentation device 10 and the learning device 11 may be appropriately changed depending on necessary performance, such as processing capacity, safety, and reliability. Further, it is needless to say that, in addition to the hardware, an application program, such as the operation programs 30 and 50, can be duplicated or distributed and stored in a plurality of storages for the purpose of securing the safety and the reliability.

In each of the above-described embodiments, for example, as a hardware structure of a processing unit that executes various types of processing, such as the RW control units 35 and 55, the sentence segmentation unit 36, the indicator derivation unit 37, the set selection unit 38, the editing unit 39, the distribution control unit 40, the learning unit 56, the first set selection unit 701, the second set selection unit 702, the selection units 85 and 105, the vectorization unit 90, the first calculation unit 911, the second calculation unit 912, and the determination unit 92, various processors shown below can be used. The various processors include, in addition to the CPUs 22A and 22B that are general-purpose processors functioning as various processing units by executing software (operation programs 30 and 50) as described above, a programmable logic device (PLD) such as a field programmable gate array (FPGA) that is a processor having a circuit configuration changeable after manufacturing, a dedicated electric circuit such as an application specific integrated circuit (ASIC) that is a processor having a circuit configuration dedicatedly designed to execute specific processing, and the like.

One processing unit may be configured by one of the various processors, or may be configured by a combination of two or more processors of the same type or different types (for example, a combination of a plurality of FPGAs and/or a combination of a CPU and an FPGA). Alternatively, a plurality of processing units may be composed of one processor.

As an example in which the plurality of processing units are configured by one processor, first, as represented by a computer such as a client and a server, there is a form in which one processor is configured by a combination of one or more CPUs and software and the processor functions as the plurality of processing units. Second, as represented by a system on chip (SoC) or the like, there is a form in which a processor that realizes the functions of the entire system including a plurality of processing units by one integrated circuit (IC) chip is used. As described above, as a hardware structure, various types of processing units are configured by using one or more of the various processors.

Further, as a hardware structure of the various processors, more specifically, an electrical circuit (circuitry) in which circuit elements such as semiconductor elements are combined can be used.

The technology according to the following supplementary notes can be understood from the above description.

### [Supplementary Note 1]

A learning support device comprising: a processor, in which the processor is configured to: acquire existing training data for a language model, which includes input data and ground-truth data, at least one of the input data or the ground-truth data being a text, the input data including a plurality of first constituent elements and the ground-truth data including a plurality of second constituent elements; derive an indicator representing a relationship between the first constituent element and the second constituent element; select a set of the first constituent element and the second constituent element for which the indicator satisfies a preset condition; and generate new training data by performing editing processing associated with the selected set on the existing training data.

### [Supplementary Note 2]

The learning support device according to Supplementary Note 1, in which the indicator is at least one of a surface similarity between the first constituent element and the second constituent element, a semantic similarity between the first constituent element and the second constituent element, a keyword similarity between the first constituent element and the second constituent element, a numerical value corresponding to a result of topic classification of the first constituent element and the second constituent element, a numerical value corresponding to a determination result of textual entailment between the first constituent element and the second constituent element, or a coverage rate of, with respect to one of the first constituent element or the second constituent element, the other of the first constituent element or the second constituent element.

### [Supplementary Note 3]

The learning support device according to Supplementary Note 2, in which, in a case where the indicator is the coverage rate, the processor is configured to: perform a first selection of selecting a set of the first constituent element and the second constituent element for which the coverage rate satisfies a first selection condition; derive an integrated coverage rate of a common constituent element with respect to an integrated constituent element obtained by integrating two or more constituent elements of the other of the first constituent element and the second constituent element, the common constituent element being selected in common to the two or more constituent elements of the other and being a constituent element of the one of the first constituent element and the second constituent element; and perform a second selection of selecting a set of the first constituent element and the second constituent element for which the coverage rate satisfies a second selection condition more stringent than the first selection condition and selecting a set of the common constituent element and the integrated constituent element for which the integrated coverage rate satisfies the second selection condition.

### [Supplementary Note 4]

The learning support device according to any one of Supplementary Notes 1 to 3, in which the processor is configured to: derive the indicator between one of the first constituent elements and one of the second constituent elements; and the indicator between two or more of the first constituent elements and one of the second constituent elements.

### [Supplementary Note 5]

The learning support device according to any one of Supplementary Notes 1 to 4, in which the first constituent element and the second constituent element are each a sentence.

### [Supplementary Note 6]

The learning support device according to any one of Supplementary Notes 1 to 5, in which the processor is configured to: perform, as the editing processing, at least one of first editing processing of generating the new training data using only the selected sets of the first constituent element and the second constituent element in the existing training data, second editing processing of generating the new training data by integrating the selected sets of the first constituent element and the second constituent element in a plurality of pieces of the existing training data, third editing processing of generating the new training data by deleting the selected sets of the first constituent element and the second constituent element in the existing training data, or fourth editing processing of generating the new training data by changing an order of the selected sets of the first constituent element and the second constituent element in the existing training data.

### [Supplementary Note 7]

The learning support device according to Supplementary Note 6, in which the processor is configured to: use a sentence order arrangement model that arranges an order of sentences in an input text in a case where the new training data is generated by performing at least one of the second editing processing or the fourth editing processing.

### [Supplementary Note 8]

The learning support device according to any one of Supplementary Notes 1 to 7, in which the processor is configured to: select data to be formally adopted as training data from among candidates for a plurality of pieces of the new training data generated by the editing processing.

### [Supplementary Note 9]

The learning support device according to Supplementary Note 8, in which the processor is configured to: perform the selection based on a first degree of deviation between target new training data and the existing training data, which is a source of the target new training data, and new training data other than the target new training data, and a second degree of deviation between the target new training data and a set of the existing training data.

### [Supplementary Note 10]

The learning support device according to Supplementary Note 8 or 9, in which the processor is configured to: perform the selection using a text semantic determination model that outputs a score representing semantic clarity of an input text.

### [Supplementary Note 11]

The learning support device according to any one of Supplementary Notes 1 to 10, in which the language model is a model that performs a task of converting an input text into an output text of a different style.

### [supplementary Note 12]

The learning support device according to any one of Supplementary Notes 1 to 11, in which the processor is configured to: train the language model using at least the new training data.

### [Supplementary Note 13]

The learning support device according to Supplementary Note 12, in which the processor is configured to: train the language model using the new training data, and then train the language model using the existing training data.

### [Supplementary Note 14]

The learning support device according to Supplementary Note 12 or 13, in which there are a plurality of types of the editing processing, and the processor is configured to: train the language model by providing the new training data generated for each of the plurality of types of editing processing to the language model in stages.

### [Supplementary Note 15]

The learning support device according to Supplementary Note 14, in which the processor is configured to: train the language model by providing the new training data to the language model in order from new training data having a relatively low training load.

### [Supplementary Note 16]

The learning support device according to any one of Supplementary Notes 1 to 15, in which the processor is configured to: determine whether or not to select a set of the first constituent element and the second constituent element to be determined by using a set selection determination model; generate the new training data by performing the editing processing associated with the set of the first constituent element and the second constituent element to be determined on the existing training data in a case where a determination result of the set selection determination model is that the set is selected; train the language model using the generated new training data; and adopt an output process of the determination result of the set selection determination model in a case where performance of the language model is improved as compared with before training using the new training data, and the processor is configured not to adopt the output process of the determination result of the set selection determination model in a case where the performance of the language model deteriorates as compared with before the training using the new training data.

The technology of the present disclosure can also appropriately combine various embodiments and/or various modification examples described above. It goes without saying that the present disclosure is not limited to each of the embodiments described above, and various configurations can be employed without departing from the gist. Furthermore, the technology of the present disclosure extends to a storage medium that non-transitorily stores the program, and a computer program product including the program, in addition to the program.

The description content and the shown content described above are detailed descriptions of parts related to the technology of the present disclosure and are merely an example of the technology of the present disclosure. For example, the above description of the configuration, the function, the operation, and the effect is the description of examples of the configuration, the function, the operation, and the effect of the parts according to the technology of the present disclosure. Accordingly, it goes without saying that unnecessary parts may be deleted, new elements may be added, or replacements may be made with respect to the description content and the shown content described above within a range that does not depart from the gist of the technology of the present disclosure. Further, in order to avoid complication and facilitate understanding of the parts according to the technology of the present disclosure, the description related to common general knowledge not requiring special description in order to implement the technology of the present disclosure is omitted in the description content and the shown content described above.

In the present specification, “A and/or B” is synonymous with “at least one of A or B”. That is, “A and/or B” means that it may be only A, only B, or a combination of A and B. In addition, in the present specification, in a case where three or more matters are expressed by being connected by “and/or”, the same concept as “A and/or B” is applied.

All documents, patent applications, and technical standards described in the present specification are incorporated in the present specification by reference to the same extent as in a case where each of the documents, the patent applications, and the technical standards are specifically and individually indicated to be incorporated by reference.

What is claimed is:

1. A learning support device comprising:
a processor,
wherein the processor is configured to:
acquire existing training data for a language model, which includes input data and ground-truth data, at least one of the input data or the ground-truth data being a text, the input data including a plurality of first constituent elements and the ground-truth data including a plurality of second constituent elements;
derive an indicator representing a relationship between the first constituent element and the second constituent element;
select a set of the first constituent element and the second constituent element for which the indicator satisfies a preset condition; and
generate new training data by performing editing processing associated with the selected set on the existing training data.

2. The learning support device according to claim 1,
wherein the indicator is at least one of a surface similarity between the first constituent element and the second constituent element,
a semantic similarity between the first constituent element and the second constituent element,
a keyword similarity between the first constituent element and the second constituent element,
a numerical value corresponding to a result of topic classification of the first constituent element and the second constituent element,
a numerical value corresponding to a determination result of textual entailment between the first constituent element and the second constituent element, or
a coverage rate of, with respect to one of the first constituent element or the second constituent element, the other of the first constituent element or the second constituent element.

3. The learning support device according to claim 2,
wherein, in a case where the indicator is the coverage rate,
the processor is configured to:
perform a first selection of selecting a set of the first constituent element and the second constituent element for which the coverage rate satisfies a first selection condition;
derive an integrated coverage rate of a common constituent element with respect to an integrated constituent element obtained by integrating two or more constituent elements of the other of the first constituent element and the second constituent element, the common constituent element being selected in common to the two or more constituent elements of the other and being a constituent element of the one of the first constituent element and the second constituent element; and
perform a second selection of selecting a set of the first constituent element and the second constituent element for which the coverage rate satisfies a second selection condition more stringent than the first selection condition and selecting a set of the common constituent element and the integrated constituent element for which the integrated coverage rate satisfies the second selection condition.

4. The learning support device according to claim 1,
wherein the processor is configured to: derive
the indicator between one of the first constituent elements and one of the second constituent elements; and
the indicator between two or more of the first constituent elements and one of the second constituent elements.

5. The learning support device according to claim 1,
wherein the first constituent element and the second constituent element are each a sentence.

6. The learning support device according to claim 1,
wherein the processor is configured to:
perform, as the editing processing, at least one of
first editing processing of generating the new training data using only the selected sets of the first constituent element and the second constituent element in the existing training data,
second editing processing of generating the new training data by integrating the selected sets of the first constituent element and the second constituent element in a plurality of pieces of the existing training data,
third editing processing of generating the new training data by deleting the selected sets of the first constituent element and the second constituent element in the existing training data, or
fourth editing processing of generating the new training data by changing an order of the selected sets of the first constituent element and the second constituent element in the existing training data.

7. The learning support device according to claim 6,
wherein the processor is configured to:
use a sentence order arrangement model that arranges an order of sentences in an input text in a case where the new training data is generated by performing at least one of the second editing processing or the fourth editing processing.

8. The learning support device according to claim 1,
wherein the processor is configured to:
select data to be formally adopted as training data from among candidates for a plurality of pieces of the new training data generated by the editing processing.

9. The learning support device according to claim 8,
wherein the processor is configured to:
perform the selection based on a first degree of deviation between target new training data and the existing training data, which is a source of the target new training data, and new training data other than the target new training data, and a second degree of deviation between the target new training data and a set of the existing training data.

10. The learning support device according to claim 8,
wherein the processor is configured to:
perform the selection using a text semantic determination model that outputs a score representing semantic clarity of an input text.

11. The learning support device according to claim 1,
wherein the language model is a model that performs a task of converting an input text into an output text of a different style.

12. The learning support device according to claim 1,
wherein the processor is configured to:
train the language model using at least the new training data.

13. The learning support device according to claim 12,
wherein the processor is configured to:
train the language model using the new training data, and then train the language model using the existing training data.

14. The learning support device according to claim 12,
wherein there are a plurality of types of the editing processing, and
the processor is configured to:
train the language model by providing the new training data generated for each of the plurality of types of editing processing to the language model in stages.

15. The learning support device according to claim 14,
wherein the processor is configured to:
train the language model by providing the new training data to the language model in order from new training data having a relatively low training load.

16. An operation method of a learning support device, comprising:
acquiring existing training data for a language model, which includes input data and ground-truth data, at least one of the input data or the ground-truth data being a text, the input data including a plurality of first constituent elements and the ground-truth data including a plurality of second constituent elements;
deriving an indicator representing a relationship between the first constituent element and the second constituent element;
selecting a set of the first constituent element and the second constituent element for which the indicator satisfies a preset condition; and
generating new training data by performing editing processing associated with the selected set on the existing training data.

17. A non-transitory computer-readable storage medium storing an operation program of a learning support device causing a computer to execute a process comprising:
acquiring existing training data for a language model, which includes input data and ground-truth data, at least one of the input data or the ground-truth data being a text, the input data including a plurality of first constituent elements and the ground-truth data including a plurality of second constituent elements;
deriving an indicator representing a relationship between the first constituent element and the second constituent element;
selecting a set of the first constituent element and the second constituent element for which the indicator satisfies a preset condition; and
generating new training data by performing editing processing associated with the selected set on the existing training data.
